(19) United States
(12) Patent Application Publication
(10) Pub. No.: US 2009/0326925 A1
(43) Pub. Date: Dec. 31, 2009

(54) PROJECTING SYNTACTIC INFORMATION USING A BOTTOM-UP PATTERN MATCHING ALGORITHM

(75) Inventors: Anthony L. Crider, Mill Creek, WA (US); Donald E. Baisley, Redmond, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/335,206

(22) Filed: Dec. 15, 2008

Related U.S. Application Data
(60) Provisional application No. 61/076,313, filed on Jun. 27, 2008.

(51) Int. Cl. G10L 15/18

(52) U.S. Cl. 704/9; 704/E15.024

(57) ABSTRACT

Embodiments for converting a token collection that is derived from a natural language expression into a computational independent model (CIM) syntax tree representation are disclosed. In accordance with one embodiment, the conversion includes deriving a plurality of tokens from a natural language expression, where each of the plurality of tokens including at least one word. The conversion further includes transforming the plurality of tokens into a CIM syntax tree representation based on a CIM phrase tree model. The conversion also includes providing the CIM syntax tree representation to an application.

### CROSS REFERENCE TO RELATED APPLICATIONS

This application claims priority to U.S. Provisional Patent Application No. 61/076,313 to Crider et al., entitled “Projecting Syntactic Information Using a Bottom-Up Pattern Match Algorithm”, filed on Jun. 27, 2008, and incorporated herein by reference. This application is related to concurrently-filed U.S. patent application Ser. No. ______ (Attorney Docket No. MS1-3797US), entitled “Projecting Semantic Information from a Language Independent Syntactic Model,” which is incorporated herein by reference.

### BACKGROUND

Natural language used by humans to communicate tends to be contextual and imprecise. For example, the simple expression “every man likes some woman” may have several different meanings. The first meaning is that there is a one-to-one mapping between each man from a plurality of men and a woman from a plurality of women that the man likes, where each man likes a different woman. However, there may be a second meaning to this simple expression. In this second meaning, “some woman” may indicate a particular woman that is unspecified. Given this interpretation, the expression “every man likes some woman” may mean that each of a plurality of men likes the same woman.

In the area of computer programming, one of the goals of computer programmers is to develop translation software that are able to automatically convert natural language expressions that represent software configuration parameters into computer code. However, due to the imprecise nature of natural language described above, one of the problems is that any automatic conversion process may result in computer applications that contain logical errors.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments of various technologies for implementing a computational independent model (CIM) phrase tree model that converts CIM token collections, as generated from natural language expressions, into a CIM syntax tree representation. The CIM syntax tree representation, as generated by the embodiments described herein, may then be converted into CIM rule expressions. In turn, the CIM rule expressions may eventually be processed into a “blueprint” for a computer program by other software.

Moreover, additional translation software may further process the “blueprint” into a computer application. Accordingly, embodiments described herein make it possible to automatically create computer programs from natural language expressions. In one embodiment, the conversion of a token collection into a computational independent model (CIM) syntax tree representation includes deriving a plurality of tokens from a natural language expression, where each of the plurality of tokens including at least one word. The conversion further includes transforming the plurality of tokens into a CIM syntax tree representation based on a CIM phrase tree model. The conversion also includes providing the CIM syntax tree representation to an application. Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram illustrating exemplary components of a computational independent model (CIM) phrase tree model transformer for converting a CIM token collection into a CIM syntax tree representation, in accordance with various embodiments.

FIGS. 2a-2g are block diagrams illustrating an exemplary representation of a computational independent model (CIM) phrase tree model in accordance with various embodiments.

FIG. 3 is a block diagram illustrating an exemplary computational independent model (CIM) syntax tree representation that is derived from an exemplary natural language expression, in accordance with various embodiments.

FIG. 4 is a block diagram illustrating an exemplary computational independent model (CIM) rule expression that is derived from an exemplary CIM syntax tree representation, in accordance with various embodiments.

FIG. 5 is a flow diagram illustrating an exemplary process for parsing a natural language expression into a computational independent model (CIM) syntax tree representation using a CIM phrase tree model, in accordance with various embodiments.

FIGS. 6a and 6b are a flow diagram illustrating an exemplary process for projecting base nominal expressions in accordance with various embodiments.

FIG. 7 is a flow diagram illustrating an exemplary process for projecting base predicate expressions in accordance with various embodiments.

FIG. 8 is a flow diagram illustrating an exemplary process for projecting predicate expressions in accordance with various embodiments.

FIG. 9 is a flow diagram illustrating an exemplary process for processing helper verbs in a predicate complex in accordance with various embodiments.

FIG. 10 is a flow diagram illustrating an exemplary process for projecting value expressions in accordance with various embodiments.

FIG. 11 is a flow diagram illustrating an exemplary process for parsing value expressions in accordance with various embodiments.

FIG. 12 is a flow diagram illustrating an exemplary process for projecting sentential structure in accordance with various embodiments.

FIG. 13 is a flow diagram illustrating an exemplary process for projecting functional restrictive structure in accordance with various embodiments.

FIG. 14 is a flow diagram illustrating an exemplary process parsing one or more conditional subclauses and/or one or more sentential expressions in accordance with various embodiments.

FIG. 15 is a block diagram illustrating a representative computing device. The representative computing device may be used to implement a computational independent model (CIM) phrase tree model transformer, in accordance with various embodiments.

### DETAILED DESCRIPTION

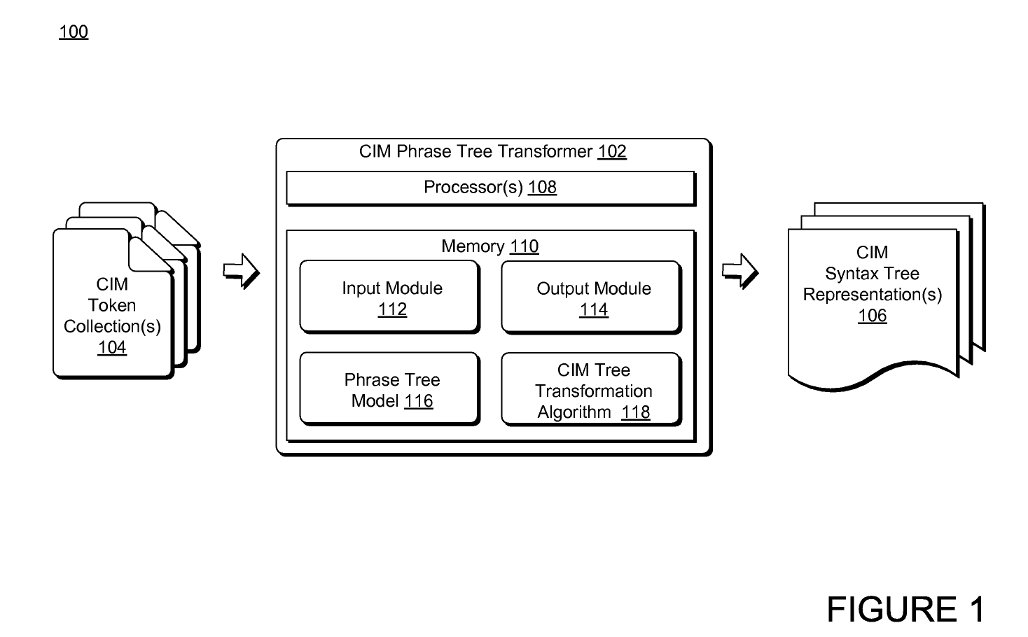

This disclosure is directed to embodiments that facilitate the conversion of computational independent model (CIM) token collections into CIM syntax tree representations. The CIM syntax tree representations may be further processed into CIM rule expressions. In turn, the CIM rule expressions may be additional processed by a code generation program to produce computer applications. Specifically, the embodiments described herein are directed to using a CIM phrase tree model to convert token collections, as derived from natural language expressions, into CIM syntax tree representations. Specifically, the CIM phrase tree model is configured to provide a framework for derive CIM syntax tree representations from corresponding CIM token collections. In this way, the use of the CIM phrase tree model may assist in the generation computer applications from natural language expressions. Various examples of CIM phrase tree model usage to produce CIM syntax tree representations are described below with reference to FIGS. 1-15.

### Exemplary Conversion Concept

FIG. 1 is a block diagram 100 illustrating exemplary components of a computational independent model (CIM) phrase tree transformer 102. The CIM phrase tree transformer 102 may be configured to convert one or more CIM token collections 104 into one or more corresponding CIM syntax tree representations 106.

The CIM token collections 104 are lists of tokens derived from natural language expressions. Natural expressions are expression that are spoken or written by humans for general-purpose communication. For example, “it is required that every employee that has exactly one office is assigned exactly one employee id” is a natural language expression. As described herein, CIM token collections 104 may serve as the basis for the automatic generation of computer applications.

CIM syntax tree representations 106 are formal representations that are based on structured syntax. Accordingly, while the meanings of natural language expressions may be dependent on the context in which the expressions are presented, CIM syntax tree representations may provide generally non-ambiguous representations of the corresponding natural language expressions. The CIM syntax tree representations may also be further converted into CIM rule expressions. In the field of information technology, CIM rule expressions, also referred to as business rules, may be used by business professionals as “blueprints” for developing software applications.

In some instances, software translators have been developed to automatically generate computer code based on CIM rule expressions. For example, such methods are disclosed in commonly owned, co-pending U.S. Publication No. 2005/0256371, filed on Apr. 30, 2004, entitled “Generating Programmatic Interfaces from Natural Language Expressions of Authorizations for Request of Information,” commonly owned U.S. Patent Publication No. 2005/0246157, filed on Apr. 30, 2004, entitled “Generating Programmatic Interfaces from Natural Language Expressions of Authorization for Provision of Information,” and commonly owned U.S. Publication No. 2006/0026576, filed on Feb. 2, 2006, entitled “Generating a Database Model from Natural Language Expressions of Business Rules,” the contents of which are herein incorporated by reference.

As described above, The CIM phrase tree transformer 102 may be configured to convert one or more CIM token collections 104 into one or more corresponding computational independent model (CIM) syntax tree representations 106. The CIM phrase tree transformer 102 may include one or more processors 108 and a memory 110. The memory 110 may include volatile and/or nonvolatile memory, removable and non-removable media implemented in any method or technology for storage of information, such as computer-readable instructions, data structures, program modules or other data. Such memory may include, but is not limited to, random access memory (RAM), read-only memory (ROM), Electrically erasable programmable read-only Memory (EEPROM), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system.

The memory 110 of the CIM phrase tree transformer 102 may store an input module 112, an output module 114, a CIM phrase tree model 116, and a CIM tree transformation algorithm 118. The input module 112 may be configured to receive one or more CIM token collections 104 into the CIM phrase tree transformer 102. By example, but not limitation, the input module 112 may receive token collections from a data storage that contains the CIM token collections 104, or a user interface (not shown) that receives inputs of the CIM token collections 104 from another data source.

The CIM phrase tree model 116 may serve as a structural scheme for the generation of the CIM syntax tree representations 106 from the CIM token collections 104. As further described below, the CIM tree transformation algorithm 118 may convert the CIM token collections 104 into CIM syntax tree representations 106 using the CIM phrase tree model 116 through various processes, as further described below.

The output module 114 may be configured to present the CIM syntax tree representations 106 to another mechanism. By example, but not limitation, the output module 114 may present the CIM syntax tree representations 106 to a software mechanism that processes the CIM syntax tree representations 106 into CIM Rule Expressions and/or other intermediate representations. In turn, these intermediate representations may be further converted into computer code. In other non-limiting examples, the output module 114 may be configured to present the CIM rule expression 106 on a display device for viewing, or for storage in a data storage device.

### Exemplary Computational Independent Model (CIM) Phrase Tree Model

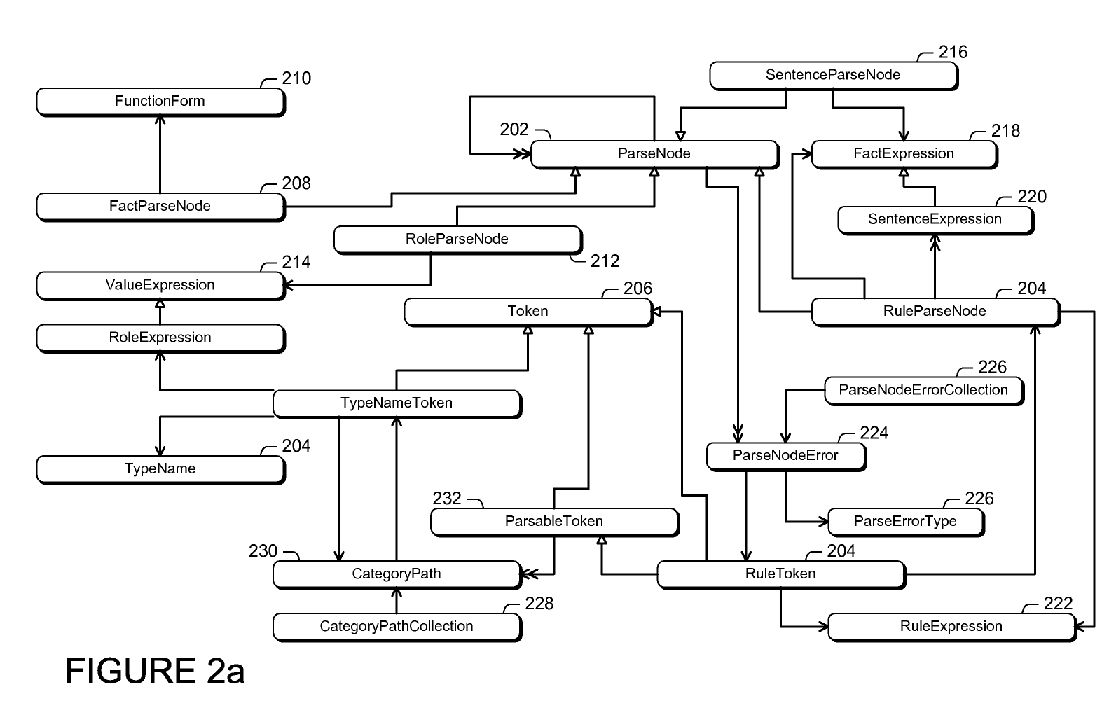

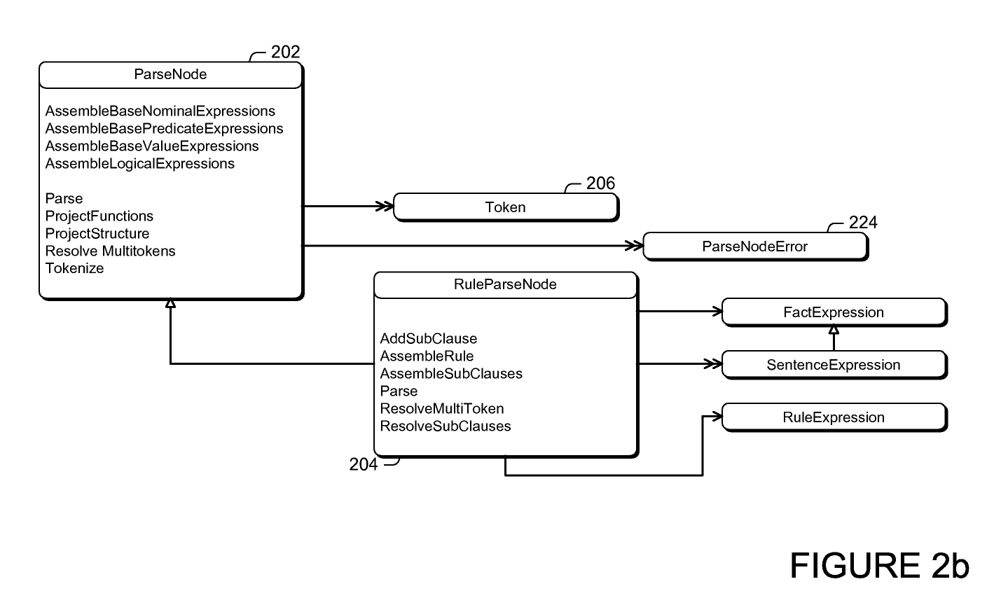

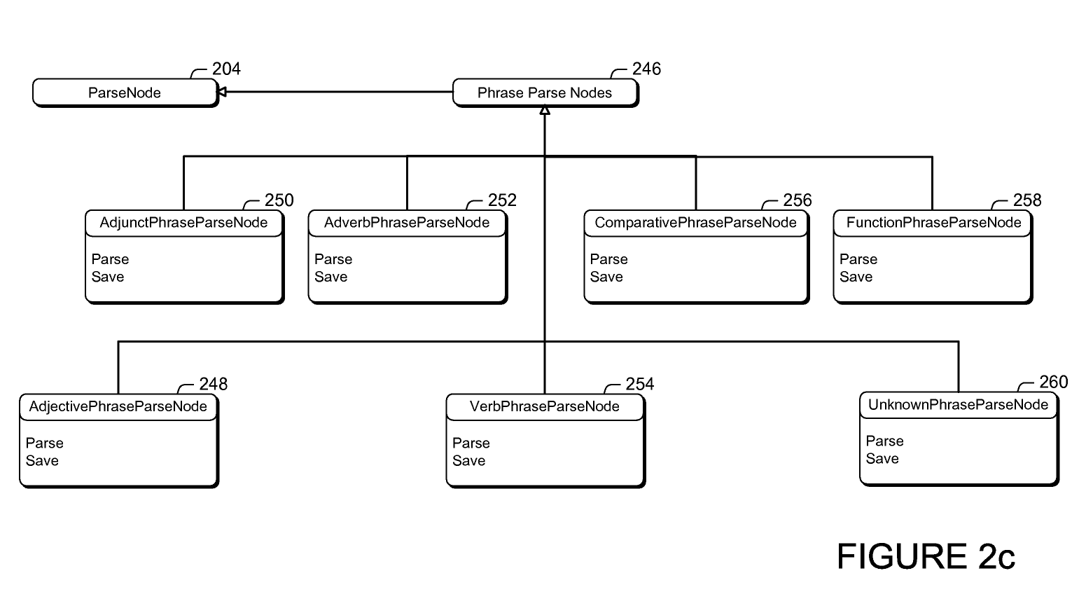

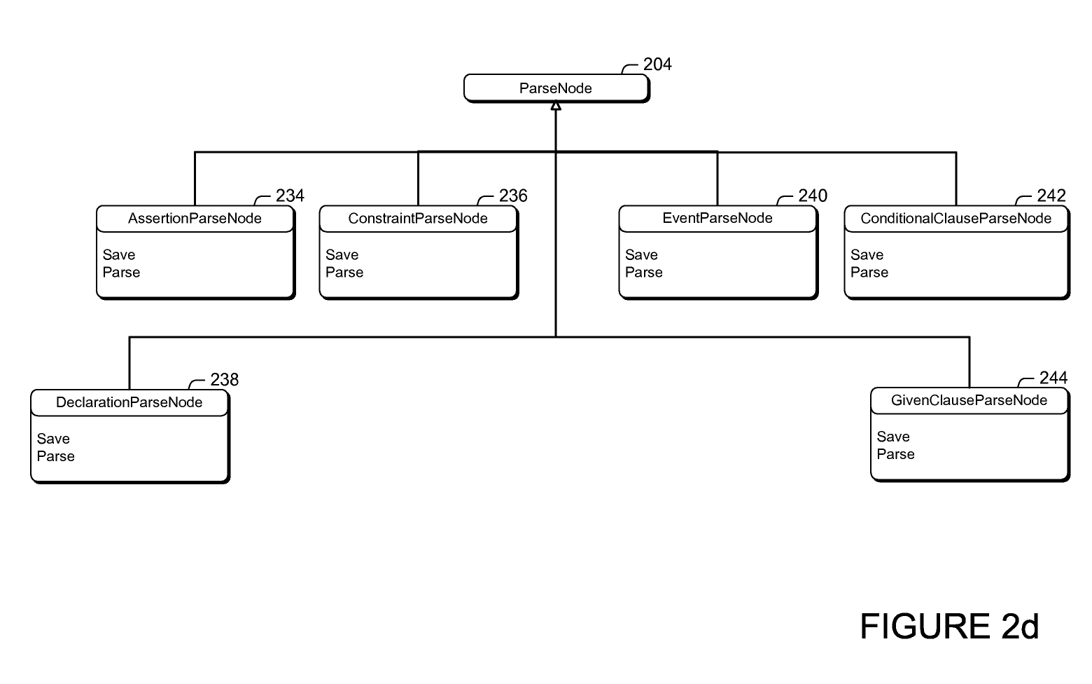

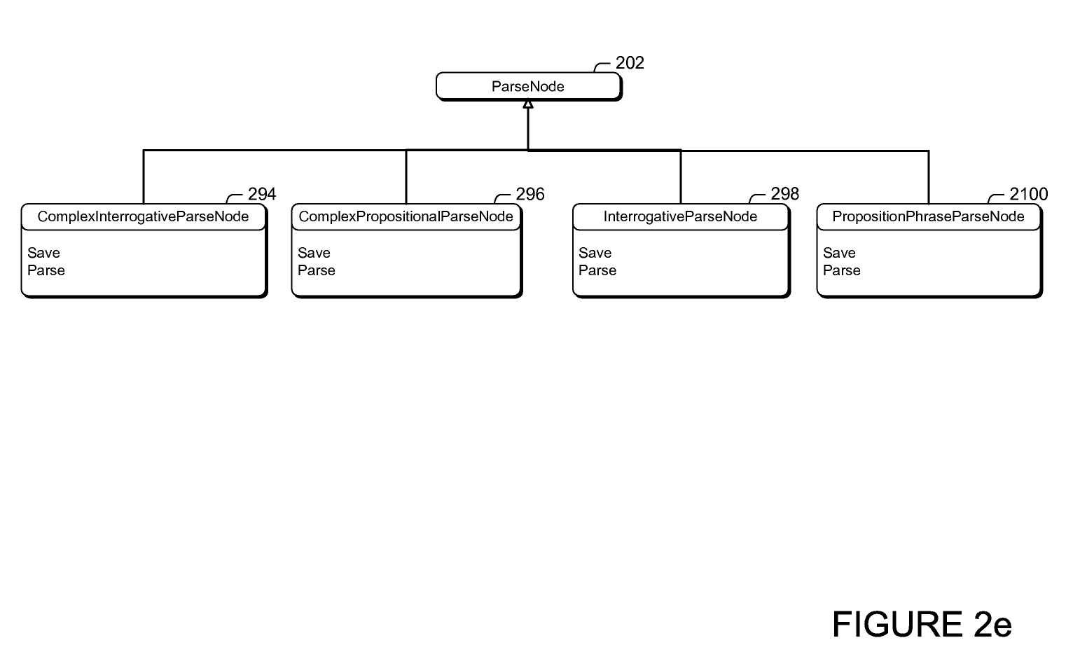

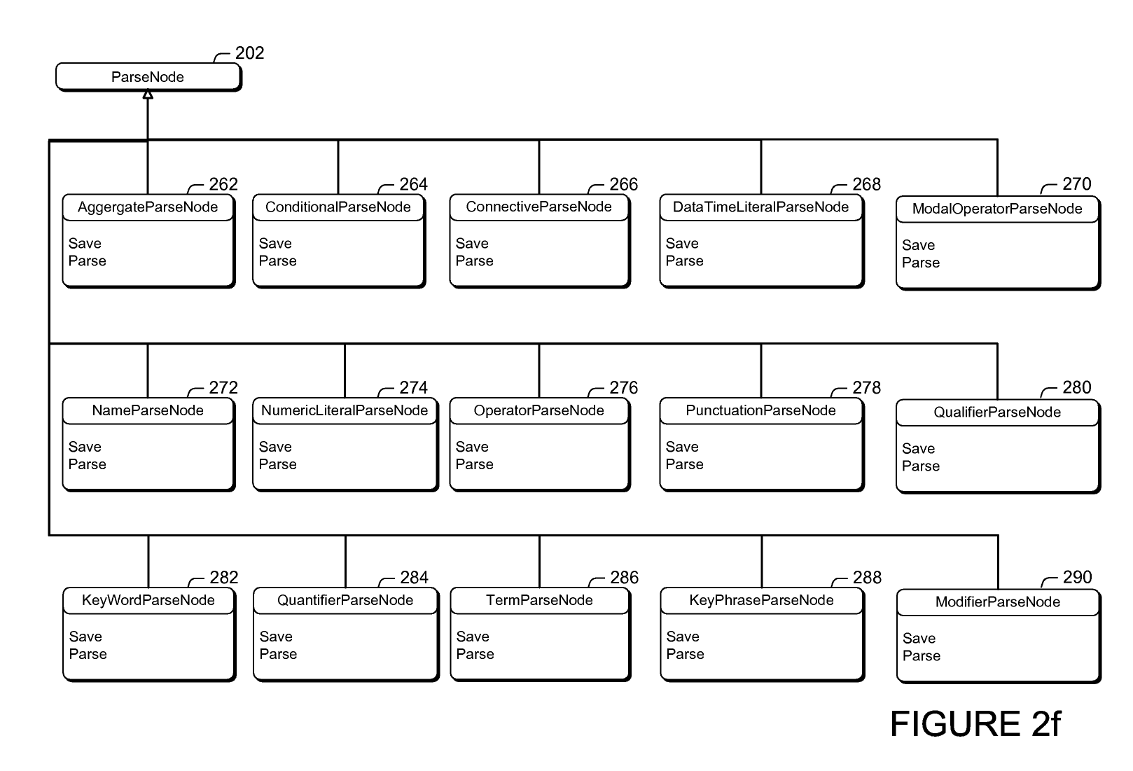

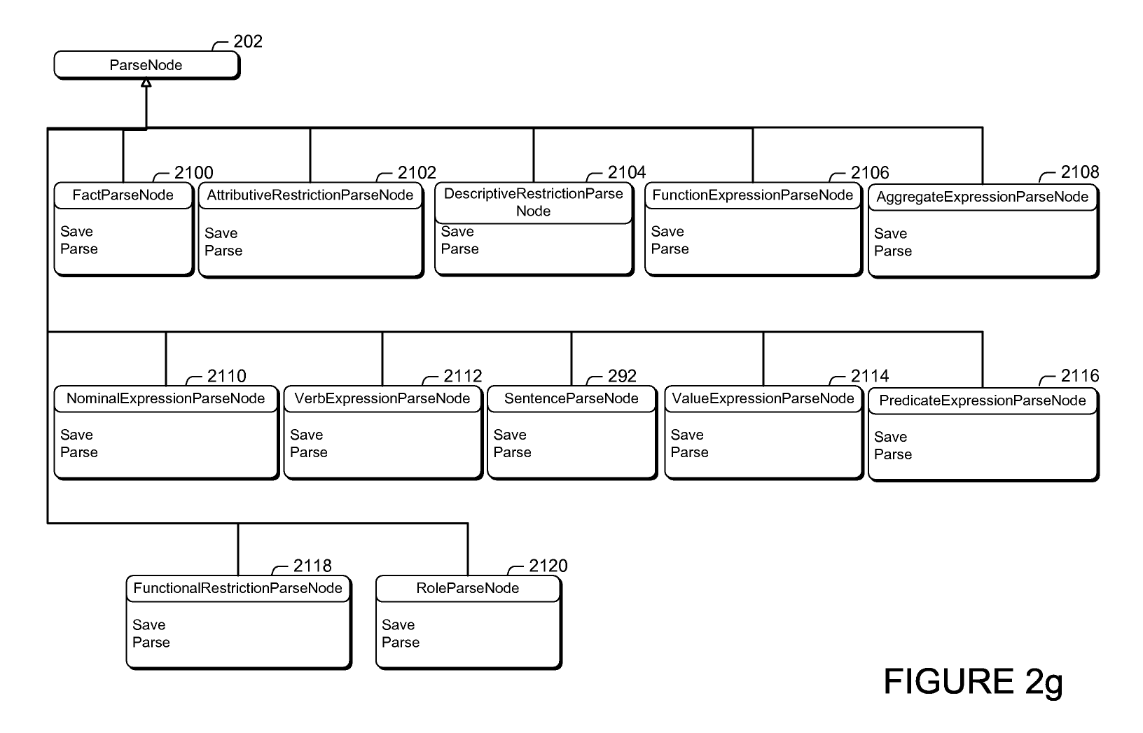

FIGS. 2a-2g are block diagrams illustrating an exemplary representation of a computational independent model (CIM) phrase tree model 116 in accordance with various embodiments. The CIM phrase tree model 116 may be constructed to enable the transformation of a plurality of tokens, such as CIM token collection 104, into a CIM syntax tree representation 106.

Many relevant linguistic terms are used in FIGS. 2a-2g, as well as in further description of other figures. These terms are developed using a linguistic terminology that includes a number of terms. For example, these linguistic terms may include, but is not limited to, “expression”, “nominal expression”, “term”, “name”, etc., as further described below.

An expression is a symbol or combination of symbols that means something. The meaning can be anything, including a proposition, a rule, a number, etc. A nominal expression is an expression that names a thing or things. A symbol is something representing, in the sense of meaning, something else. A term is a symbol that denotes being of a type, i.e., a common noun. Examples: “car” denoting a category of vehicle.

A name is a symbol and a nominal expression, or a symbol that names an individual thing, i.e., a proper noun. For example, the noun “California” names a state of the United States, and the noun “Microsoft” names the Microsoft Corporation of Redmond, Wash.

A numerical literal is a name that denotes a number using numerals. For example, the numerical literal “123” meaning the number 123. A textual literal includes a symbol and a nominal expression. Symbols are words, punctuation, textual characters or a sequence of any of these by literal presentation, such as in quotation marks. For example, “hello” represents the word “hello”.

A role expression is a nominal expression that consists primarily of a term given in place of a placeholder in an expression based on a function form, and consists secondarily of each operator (e.g., quantifier, pronominal operator, parametric operator, interrogative operator) and object modifier applied to the term together with any expression of instances specifically referenced by the term, or, if the denoted type's range is restricted using a nominal restrictive form, that nominal restrictive form along with the expression of each argument to the function delineated by that form. Examples of nominal expressions include: “a checking account” in the expression “a checking account has the overdraw limit ($1000.00)”; “the overdraw limit ($1000.00)” in the expression “a checking account has the overdraw limit ($1000.00)”.

A value expression is a category of nominal expression. It is stated using a mathematical form and includes a nominal expression for each placeholder of the mathematical form.

A sentence is an expression that denotes a proposition (possibly an open or interrogative proposition). A simple sentence is a sentence that is stated using a single sentence form, that is, there are no logical connectives. A simple sentence includes a nominal expression for each placeholder of the sentence form. For example, “each person has a name” is a simple sentence. On the other hand, a complex sentence is a sentence that combines other sentences using a logical connective such as “if”, “and”, “or”, etc. For example, “each American citizen has a name and a social security number” is a complex sentence.

A function form is a symbol and an expression. A complex symbol is a sequence of typed placeholders and words interspersed that delineates a function and serves as a form for invoking the function in expressions. Each typed placeholder appears in the sequence as a term denoting the placeholder's type specially marked in some way (such as by underlining).

A nominal restrictive form is a category of function form. Specifically, a nominal restriction form is a function form that can be in the form of a nominal expression and that includes a placeholder representing the function result of the delineated function. For examples, “doctor of patient” as form of expressing the doctor or doctors that a patient has, and “patient seen by doctor” as form of expressing the patients that a doctor sees.

A mathematical form is a category of function form. Specifically, a mathematical form is a function form that can be the form of a nominal expression and that does not include a placeholder representing the function result of the delineated function. For example, “number+number” as in “2+3” giving 5. Moreover, “number of days after date” as in “6 days after Oct. 30, 2008” giving another date.

A sentence form is a category of function form that delineates a propositional function. For example, “vendor charges price for product” is a sentence form. A placeholder is an open position with a designated type in a functional form that stands in place of a nominal expression that would appear in an expression based on that form.

A placeholder represents an argument or a result in the function delineated by the functional form. For example, “doctor” and “patient” in “doctor sees patient” are exemplary placeholders. Likewise, “vendor”, “price”, and “product” in “vendor changes price for product” are also exemplary placeholders.

A function signifier is a role of a signifier as part of a function form that appears in an expression based on the function form. It is a part of a function form that is not a placeholder. Examples of function signifiers include “sees” in “doctor sees patient”, and “changes” and “for” in “vendor changes price for product”.

An argument is an independent variable in a function. An object qualifier is a category of symbol. It is a symbol that, when used with a term, restricts the meaning of the term in some specific way. For example, the symbol “new” in “A doctor sees a new patient” is an object qualifier.

A parametric operator is an operator that when expressed with a term denotes a discourse referent determined by a future discourse context, with singular quantification. For example, “a given” in “Each medical receptionist is authorized to provide what doctor sees a given patient” is an argument.

An interrogative operator is a category of operator that, when expressed with a term in a role expression, denotes a discourse referent determined by future discourse context. The role expression is thus a name for satisfiers in the encompassing sentence. Examples of interrogative operators include the operator “what” in “What doctor sees what patient”’; the operators “which” and “what” in “Which doctor sees what patient”. It will be appreciated that “what” carries the meaning of “who”, “when”, “how”, “where”, “why”, etc., when used as an operator on a term. Examples of such instances include “what person”, “what time” or “what date”, “what method”, “what location”, “what purpose”, etc.

A propositional interrogative is a category of operator. It is an operator that, when expressed with a proposition, denotes the truth-value of the proposition with regard to future discourse context. For example, the operator “whether” in “whether each doctor is licensed” is a propositional interrogative.

A propositional demonstrative is a category of symbol. It is a symbol that names a referent proposition thereby forming a demonstrative expression. Examples of propositional demonstratives include the word “that” in “The Orange County Register reports that Arnold is running”, the word “who” in “A customer who pays cash gets a discount”. It will be appreciated that the propositional demonstrative turns a sentence into a nominal expression.

A pronominal operator is a category of operator. It is an operator that, when expressed with a term, denotes a discourse referent determined by discourse context and has universal extension. Examples of pronominal operations include the word “the” in “a person is French if the person is from France”, the word “that” in “a person is French if that person is from France”, and the word “the” in “the social security number of a person identifies the person”. It will be appreciated that a pronominal operator refers to something in discourse or immediately to some attributive role, and invokes universal quantification over each value of the referent.

A discourse context is a discourse that surrounds a language unit and helps to determine its interpretation. For example, in the rule expression, “By default, a monthly service charge ($1.95) applies to an account if the account is active”, the role expression “the account” is interpreted in consideration of every other symbol in the rate expression, and is thereby mapped to the referent expressed as “an account”. It will be appreciated that discourse context is the means by which the pronominal operator “the” gets meaning. Since discourse context is linear, references tend to refer backwards.

A function is a mapping of correspondence between two sets. For example, number+number (addition) name of person. A propositional function is a category of function. It is a function that maps to truth values. Examples: the function delineated by “vendor sells product”; the function delineated by “customer is preferred”

A proposition is what is meant by a statement that might be true of false. A fact is a proposition that is accepted as true. An elementary proposition is a category of proposition. It is a proposition based on a single propositional function and a single thing for each argument of the function (no quantified arguments, no open arguments).

An elementary fact is a fact that is also an elementary proposition. An elementary fact type is a category of type. It is a subtype of elementary fact that is defined by a propositional function. For example, the type defined by the propositional function delineated by “vendor sells product” is an elementary fact type.

A fact type is a type that is a classification of facts. A fact type may be represented by a form of expression such as a sentence form, restrictive form or a mathematical form. A fact type has one or more roles, each of which is represented by a placeholder in a sentence form. Each instance of a fact type is a fact that involves one thing for each role. For example, a fact type “person drives car” has placeholders: person and car. An instance of the fact type is a fact that a particular person drives a particular car.

An operator is a symbol that invokes a function on a function. For example, “some”, “each definitely”, “possibly” are operators. A logical connective is a symbol that invokes a function on truth values. For example, “and”, “or if”, “only if”, “if and only if”, “given that”, and “implies” are logical connectives. A quantifier is a category of operator. It is an operator that invokes a quantification function, a linguistic form that expresses a contrast in quantity, as “some”, “all”, or “many”. For example, “some”, “each”, “at most one”, “exactly one”, and “no” are quantifiers.

It will be appreciated that a quantifier for an individual quantification function should not be confused with a name for such a function. A quantifier is not a noun or noun phrase, but an operator. For example, the quantifier “some” is a symbol that invokes the quantification function named “existential quantification”.

A quantification function is a category of function. It is a function that compares the individuals that satisfy an argument to the individuals that satisfy a proposition containing mat argument. Examples of quantification functions include the meaning of “some” in “Some person buys some product”, and the meaning of “each” in “Each person is human”.

An existential quantification is the instance of quantification function that is satisfied where at least one individual that satisfies an argument also satisfies a proposition containing that argument. Examples of existence qualifications include the meaning of “some” in “Some customer pays cash”, and the meaning of “a” in “Each customer buys a product”.

A universal quantification is the instance of quantification function that is satisfied if every individual that satisfies an argument also satisfies a proposition containing that argument. For example, the meaning of “each” in “Each customer buys a product”.

A singular quantification is the instance of quantification function that is satisfied if exactly one individual that satisfies an argument also satisfies a proposition containing that argument. For example, the meaning of “exactly one” in “Each employee has exactly one employee number”.

A negative quantification is the instance of quantification function that is satisfied if no individual that satisfies an argument also satisfies a proposition containing that argument. For example, the meaning of “no” in “No customer buys a product”.

A fact is a proposition that is accepted as true. A rule is an authoritative, prescribed direction for conduct. For example, one of the regulations governing procedure in a legislative body or a regulation observed by the players in a game, sport, or contest is a rule. It will be appreciated that a rule is not merely a proposition with a performative of a prescription or an assertion. A rule is made a rule by some authority. It occurs by a deliberate act.

An assertion rule is a category of rule, a rule that asserts the truth of a proposition. Examples of assertions rules include “Each terminologist is authorized to provide what meaning is denoted by a given signifier”, and “Each customer is a person.”

A constraint rule is a category of rule, a rule that stipulates a requirement or prohibition. Examples of constraint rules include “It is required that each term has a exactly one signifier”, “It is permitted that a person drives a car on a public road only if the person has a driver's license,” and “It is prohibited that a judge takes a bribe”.

A default rule is a category of rule, a rule that asserts facts of some elementary fact type on the condition that no fact of the type is otherwise or more specifically known about a subject or combination of subjects. Examples of default rules include “By default, the shipping address of a customer is the business address of the customer”, and “By default, the monthly service charge ($1.95) applies to an account if the account is active”.

It will be appreciated that a default rule is stated in terms of a single propositional function, possibly indirectly using a nominal restrictive form based on the propositional function. A default value is given for one argument. The other arguments are either universally quantified or are related to a condition of the rule. For each combination of possible things in the other arguments, if there is no elementary fact that is otherwise or more specifically known, and if the condition (if given) is satisfied, then the proposition involving those arguments is taken as an assertion. Note that if two default rules potentially assert facts of the same elementary fact type about the same subject thing and one of the rules is stated for a more specific type of the thing, then that rule is used (because it is more specifically stated).

An identity criterion, also called identification scheme or reference scheme, is a scheme by which a thing of some type can be identified by facts about the thing that relate the thing to signifiers or to other things identified by signifiers. The identifying scheme comprises of the set of terms that correspond to the signifiers. For example, “an employee may be identified by employee number” is an identity criterion.

A category is a role of a type in a categorization relation to a more general type. The category classifies a subset of the instances of the more general type based on some delimiting characteristic.

A type is a classification of things (often by category or by role). A category is a role of a type in a categorization relation to a more general type. The category classifies a subset of the instances of the more general type based on some delimiting characteristic. For example, a checking account is a category, that is, a type of account.

A role is a role of a type whose essential characteristic is that its instances play some part, or are put to some use, in some situation. The type classifies an instance based, not on a distinguishing characteristic of the instance itself (as with a category), but on some fact that involves the instance. For example, “destination city” is a role of a city.

A supertype is a role of a type used in relation to another type such that the other type is a category or role of the supertype, directly or indirectly. Each instance of the other type is an instance of the supertype. For example, animal is a supertype of person (assuming person is a category of animal) and person is a supertype of driver (assuming driver is a role of a person).

A subclause is a dependent clause which gives more information on one part of a main clause (or on the complete main clause). The subclause may be linked to the main clause through a subordinating conjunction, a question word or a relative pronoun. A conditional subclause is a special type of subclause that is generally included in a conditional sentence. For example, conditional subclauses generally begin with “if” or a semantically similar conjunction, such as “assuming that”, “supposing that”, “unless”, etc.

FIG. 2a is a block diagrams that illustrates the various nodes of the computational independent model (CIM) phrase tree model 116 in accordance with various embodiments. The various nodes may be configured to take a collection of CIM tokens 104 as input, and project the tokens into a syntactic structure, such as the CIM syntax tree representation 106. It will be appreciated that each node in the model 116 may be a programming object that includes methods and properties to be processed.

In various embodiments, the parse node 202 is a generalization of the model. The rule parse node 204, which derives from the parse node 202, may act as a foundational feature of the model. The rule parse node 204 may be configured to project the tokens, such as from the token collection 206, into individual parts of speech. The rule parse node 204 may project the tokens by partitioning the tokens into various parse nodes. As a result, instances of the parses nodes may represent the original tokens from the collection 206. For example, the fact parse node 208 may encode a function form 210 from a token of the token collection 206. The role parse node 212 may encode a value expression 214 from a token of the token collection 206. The sentence parse node 216 may encode a fact expression 218 from a token of the token collection 206. The rule parse node 204 may encode a sentence expression 220 from a token of the token collection 206. Once the token collection 206 has been partitioned into the various parse nodes, the rule parse node 204 may assemble the parse nodes into larger units.

The rule parse node 204 may further include a path to the rule expression 222. Accordingly, the rule parse node 204 may include a save method. The save method may be used to generate the rule expression 222. The parse node error 224 may encode errors that are generated during the projection of the token collection 204 into the parse node error collection 226. In various embodiments, the errors may then be exported from the parse node error collection 226 into another application for handling and analysis.

The category path collection 228, the category path 230, and the parsable token 232 may be used to process complex sentences (i.e., rules) that include a plurality of noun phrases that is followed by one or more pronoun. The category path collection 228 is designed to capture all the nouns and pronouns, as well as the relationship between them. For example, given the sentence “every employee must have an employee id, and the employee must have a social security number,” the occurrence of the second “employee” is a pronoun that refers back to the first occurrence of the “employee.” In other words, in this particular sentence, every “employee” that satisfies the first clause must necessarily satisfy the second clause of the sentence. Thus, the category path collection 228, the category path 230, and the parsable token 232 may be used to encode the relationship between the first occurrence of “employee” and the second occurrence of “employee” so that the relationship may be understood. Otherwise, the semantics of such complex sentences may be incorrect. It will be appreciated that the additional features shown in FIG. 2a, as further described below, are support features for facilitating the capture of the various parts of speech from a collection of tokens 206.

FIG. 2b illustrates additional features of the computational independent model (CIM) phrase tree model in accordance with various embodiments. As shown, the parse node 202 may include a plurality of methods. These methods may include an “AssembleBaseNominalExpressions” method, an “AssembleBasePredicateExpressions” method, an “AssembleBaseValueExpressions” method, an “AssembleLogicalExpressions” method, a “Parse” method, a “ProjectFunctions” method, a “ProjectStructure” method, a “Resolve Multitokens” method, and a “Tokenize” method.

Likewise, rule parse node 204 may also include a plurality of methods. These methods may include an “AddSubClause” method, an “AssembleRule” method, an “AssembleSubClauses” method, a “Parse” method, a “ResolveMultiToken” method, and a “ResolveSubClauses” method. The rule parse node 204 may process rule expressions, sentence expressions, and fact expressions.

The ParseNode 202 may use its “tokenize” method to take any token that gets passed in from token collection 206, and project the tokens into parse nodes that encode the corresponding parts of speech of the tokens. Tokens that do not have a part of speech or is otherwise unparsable (e.g., unrecognized) may be projected as undefined, and a parse node error 224 may be generated for further processing.

Once the tokens from the token collection 206 are projected into the various nodes, the RuleParseNode 204 may call its method “ResolveSubClauses.” The “ResolveSubClauses” method may break apart the projected tokens, which represent a rule expression, into various subclauses. For Example, the “ResolveSubClauses” method may extract any event clauses, any given clauses, any condition clauses, and any main clause that are present in the rule expression.

As shown in FIG. 2d, the “ResolveSubClauses” method may create one or more parse nodes during this extraction process. In various embodiments, the “ResolveSubClauses” method may create one or more of an assertion parse node 234, a constraint parse node 236, a declaration clause parse node 238, an event clause parse node 240, a conditional clause parse node 242, and a given clause parse node 244, as needed, depending on the parts of speech present in the original expression. Once the needed parse nodes are created, the “ResolveSubClauses” method may encapsulate the correspond part of speech into the created parse nodes.

Moreover, the parts of speech encapsulated in one or more of the created parse nodes 234-244 may be further encapsulated into additional parse nodes, which are created as needed to accommodate the different parts of speech that are present. These additional parse nodes are show in FIGS. 2c and 2f.

As shown in FIG. 2c, the “Tokenize” method may create one or more phrase parse nodes 246. The phrase parse nodes 246 may include an “AdjectivePhraseParseNode” 248 that may encapsulate and an adjective, an “AdjunctPhraseParseNode” 250 that may encapsulate an adjunct, an “Adverb PhraseParseNode” 252 that may encapsulate an adverb, and a “VerbPhraseParseNode 254” to encapsulate a verb. The phrase parse nodes 246 may further include a “ComparativePhraseParseNode” 256 that may encapsulate a comparative, a “FunctionPhraseParseNode” 258 that may encapsulate a function, and an “unknownPhraseParseNode” 260 that may encapsulate an unknown part of speech.

As shown in FIG. 2f, the “Tokenize” method may create one or more additional parse nodes. These additional parse nodes may include an “AggregateParseNode” 262 that may encapsulate an aggregation, a “ConditionalParseNode” 264 that may encapsulate a conditional, a “ConnectiveParseNode” 266 that may encapsulate a logical connective, a “DataTimeLiteralParseNode” 268 to encapsulate a data/time literal, and a “ModalOperatorParseNode” 270 that may encapsulate a modal operator.

The additional parse nodes may also include a “NameParseNode” 272 to encapsulate a name, a “numericLiteralParseNode” 274 to encapsulate a numeric literal, an “OperatorParseNode” 276 to encapsulate an operator, a “PunctuationParseNode” 278 that may encapsulate a punctuation, and a “QualifierParseNode” 280 that may encapsulate a qualifier.

The additional parse nodes may further include a “KeyWordParseNode” 282 that may encapsulate a keyword, a “QuantifierParseNode” 284 that encapsulate a quantifier, a “TermParseNode” 286 that may encapsulate a noun, a “KeyPhraseParseNode” 288 to encapsulate a key phrase, and a “ModifierParseNode” 290 that may encapsulate a modifier.

When the rule parse node 202 has encapsulated the various parts of speech of a token collection 206 into various corresponding parse nodes, the Rule Parse Node 202 may call its “AssembleSubClauses” method. In various embodiments, the “AssembleSubClauses” method may create an event clause parse node 240, a conditional clause parse node 242, and a given clause parse node 244, to project an event clause, a conditional clause, and a given clauses, respectively, as well as generate a sentence parse node 292. The sentence parse node 292 is illustrated in FIG. 2g.

Moreover, it will be appreciated that the assertion clause, the constraint clause, and the declaration clause of a rule expression, if any, may only be discovered after the main sentence body is parsed to discover the object of the rule expression. Thus, the assertion constraint and declaration parse nodes 240-244 may be projected subsequent to such discovery by the “AssembleRule” method of the Rule Parse Node 202.

In various embodiments, the parse node 202 may include a “parse” method that integrates large constitutes, such as a given clause, a condition, or sentence parse node into one of the higher level parse nodes in FIG. 2e, if applicable.

FIG. 2e illustrates a “ComplexInterrogativeParseNode” 294, a “ComplexPropostionalParseNode” 296, an “InterrogativeParseNode” 298, and a “PropositionalPhraseParseNode” 2100. In various embodiments, the “InterrogativeParseNode” 298 may encapsulate an intent expression (e.g., where did you go?). Similarly, the “ComplexInterrogativeParseNode” 294 may encapsulate a plurality of intent expressions (e.g., where did you go, and what did you do?). Likewise, the “PropositionalPhraseParseNode” 2100 encapsulates a propositional phrase, and the “ComplexPropostionalParseNode” 296 encapsulates a plurality of Propositional phrases.

When any parse node derived from “ParseNode” 202 (e.g., a “RuleParseNode” 204 or a “GivenGlauseParseNode” 244) has encapsulated the various sentences comprised of tokens 206 into various corresponding “SentenceParseNodes” 292, the derived parse node 202 may call its “AssembleLogicalExpressions” method. In various embodiments, the “AssembleLogicalExpressions” method may create a plurality of a “ComplexInterrogativeParseNode” 294, a “ComplexPropositionalParseNode” 296, an “InterrogativeParseNode” 298, and a “PropositionalPhraseParseNode” 2100.

Similarly, FIG. 2g illustrates additional high level parse nodes for which the basic parses nodes illustrated in FIGS. 2c and 2f may integrate into via a “parse” method of the parse node 202. These high level parse nodes may include a “FactParseNode” 2100 that may encapsulate a fact expression, “AttributiveRestrictionParseNode” 2102 that may encapsulates an attributive restriction, and “DescriptiveRestrictionParseNode” 2104 that may encapsulate a descriptive restriction, a “FunctionExpressionParseNode” 2106 that may encapsulate a function expression, an “AggregateExpressionParseNode” 2108 that may encapsulate an aggregate expression, a “NominalExpressionParseNode” 2110 that may encapsulate an nominal expression, a “VerbExpressionParseNode” 2112 that may encapsulate a verb expression, a “SentenceParseNode” 292 that may encapsulate a sentence expression, a “ValueExpressionParseNode” 2114 that may encapsulate a value expression, a “PredicateExpressionParseNode” 2118 that may encapsulate a predicate expression, a “FunctionalRestrictionParseNode” 2118 that may encapsulate functional restriction, and a “RoleParseNode 2120” that may encapsulate a role expression.

As further described below with respect to the flow diagrams, the operations of parsing, resolving sub clauses, and assembly, as performed by the various methods and nodes, may occur recursively. In at least one embodiment, the rule parse node 204 may resolve subclauses by breaking out major features of each subclause. The rule parse node 204 may then parse and project each major feature to obtain additional features and clauses. The parse node 204 may repeat the same operations for these additional features and clauses until the highest level of granularity for the constituents of a rule expression, as shown in FIGS. 2c and 2f is reached.

The Parse Node 202 may assemble the parts of speech, as stored in the various parse nodes, into a CIM syntactic tree representation. In various embodiments, and as further described below, the parse node 202 may call its “AssembleBaseNominalExpression” method to assemble base nominal expressions, “AssembleBasePredicateExpression” method to assemble base predicate expressions, “AssembleBaseValueExpression” to assemble base value expressions, “ProjectfFunctions” method to project functional restrictions that modify nominal expressions, and “ProjectStructure” method to project sentenctial structure. In various embodiments, the parse node 202 may call these methods in order. In turn, each of the “AssembleBaseNominalExpression” method and the “AssembleBasePredicateExpression” method may call the “ResolveMultiToken” method to resolve tokens that may be used for more than one part of speech (e.g., the word “walk” is both a noun and a verb), as projected into the parse nodes, into a CIM syntactic tree representation. In various embodiments, the Parse Node 202 may have the ability to verify that the CIM syntactic tree representation is syntactically valid.

It will be appreciated that the various parse nodes, as illustrated in FIGS. 2a-2g, may include a “parse” method and a “save” method. In various embodiments, the “parse” method may validate that a token projected that is projected into a corresponding node is of the valid type and may further validate that one or more parse nodes are a valid sequence of parse nodes. The “save” method stores the token into a memory (e.g., a data storage) associated with the node.

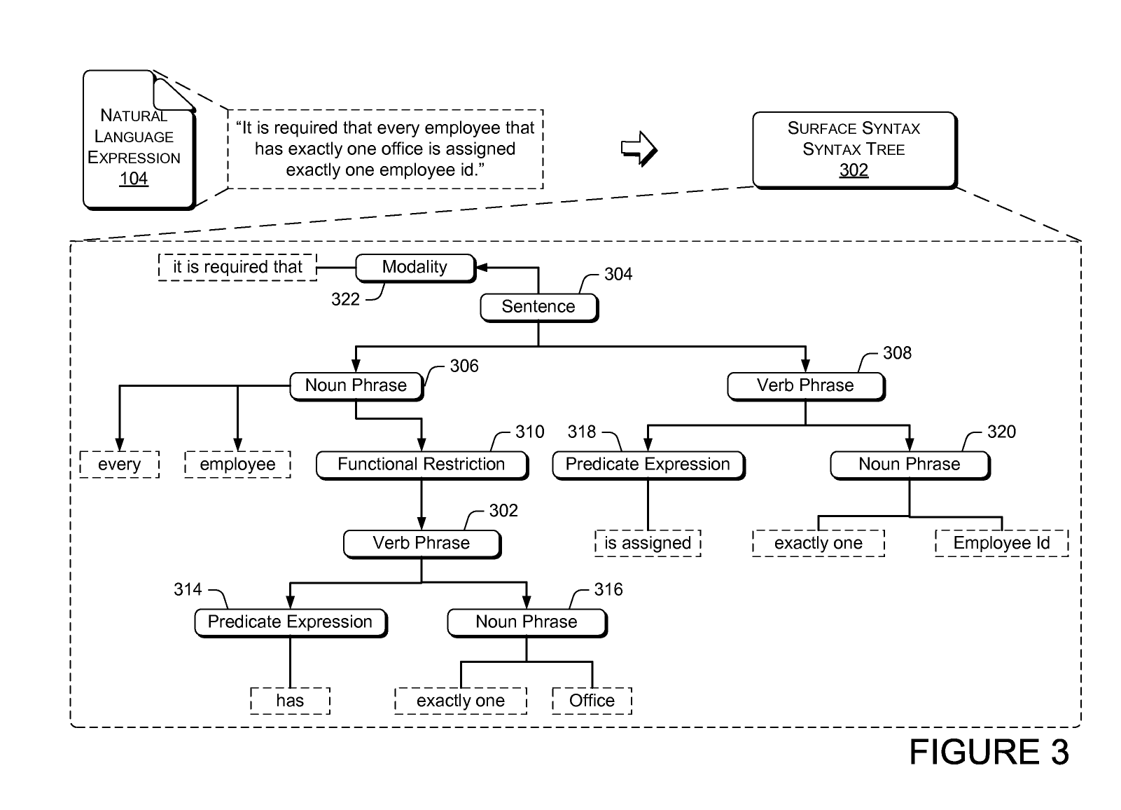

FIG. 3 is a block diagram illustrating an exemplary computational independent model (CIM) syntax tree representation 300 that is derived from an exemplary natural language expression, in accordance with various embodiments. The CIM phrase tree transformer 102 may derive the exemplary CIM syntax tree representation 302 from an exemplary natural language expression, such as embodied in the CIM token collections 104 described in FIG. 1. As shown, the exemplary natural language expression states, “It is required that every employee that has exactly one office is assigned exactly one employee id.” In various embodiments, the CIM phrase tree transformer 102 may construct the exemplary CIM syntax tree representation 302 by breaking down the natural language expression into tokens. As used herein, tokens are discrete units of linguistic expression that are commonly found in a natural language expression. For example, but not limitation, tokens that are found in a typical natural language expression may include a noun phase, a verb phrase, a predicate expression, a functional restriction, etc. These and other tokens are illustrated with respect to the exemplary CIM syntax tree representation 302.

The CIM syntax tree representation 302 is a structured representation of the natural language expression, in the form of exemplary sentence 304, “it is required that every employee that has exactly one office is assigned exactly one employee id.” The CIM syntax representation of sentence 304 may be divided into a noun expression 306 and a verb expression 308. The noun expression 306 may include the words “every employee” and a functional restriction 310. The functional restriction may include a verb phrase 312. The verb phrase 312, in turn, may be further divided into a predicate expression 314 and a noun phrase 316. The predicate expression 314 may include the word “has.” The noun phrase 316 may include the words “exactly one” and the word “office”.

The verb expression 308 may be further divided into a predicate expression 318 and a noun phrase 320. The predicate expression 318 may include the words “is assigned”. Further, the noun phrase 300 may include the words, “employee id.” The exemplary sentence 304 may be additionally modified by a modality 322. The modality 322 may include the words “it is required that.” It will be appreciated that the CIM syntax tree representation 302 may be further converted into a CIM rule expression, such as CIM rule expression 106.

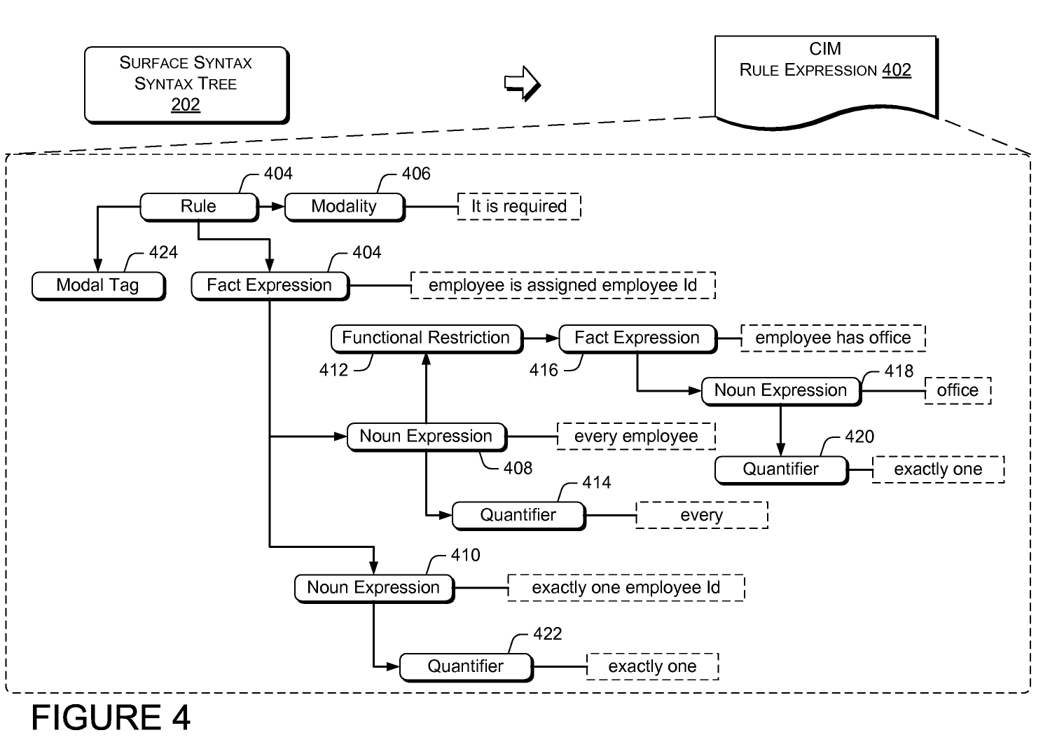

FIG. 4 is a block diagram illustrating an exemplary computational independent model (CIM) rule expression that is derived from an exemplary CIM syntax tree representation, in accordance with various embodiments. The CIM phrase tree transformer 102 may derive the CIM rule expression 402 from the CIM syntax tree representation 302 using the CIM phrase tree model 116. In various embodiments, the CIM phrase tree model 116 may contain instructions and/or algorithms that project each token of the CIM syntax tree representation 202 into a corresponding expression in the CIM rule expression 402. The CIM phrase tree model 116 may further provide instruction and/or algorithms that assemble the expressions into the CIM rule expression 402. For instance, the CIM phrase tree model 116 may contain instructions and/or that projects a rule from a sentence.

Specifically, in examples where the CIM syntax tree representation 202 represents the natural language expression, ““it is required that every employee that has exactly one office is assigned exactly one employee id,” the CIM phrase tree transformer 102 may project the CIM rule expression 402 that includes a rule 404. The rule 404 may include a fact expression 406. The fact expression 406 may comprise the words “employee is assigned employee id.” Moreover, the rule 404 may also include a modality 406. The modality 406 may indicate that the rule 404 includes a “necessity”, that is, a requirement that needs to be fulfilled in order for the expression to be implemented. The fact expression 404, in turn, may comprise a noun expression 408 and a noun expression 410.

The noun expression 408 may include the words “every employee”. Moreover, the noun expression 408 may include a functional restriction 412 and a quantifier 414. The functional restriction 412 may further comprise a fact expression 416. The fact expression 416 may include the words “employee has office.” The fact expression 416 may further comprise a noun expression 418 that includes the word “office.” The noun expression 418 may comprise a quantifier 420 that includes the words “exactly one.” Additionally, the quantifier 414 may include the word “every.”

The noun expression 410 includes the words “exactly one employee id.” Furthermore, the noun expression 410 may comprise a quantifier 422 that includes the words “exactly one.” Finally, the rule 404 may also include a modal tag 424. The modal tag 424 may enable information regarding the type of modality 406. For example, the modal tag 424 may indicate that the modality 406 is a pre-pending constraint (e.g., it is required) rather than a condition on the predicate (e.g., must be assigned). In this way, the modality tag 424 may facilitate the accurate reconstruction of natural language expression from a CIM rule expression.

### Exemplary Processes

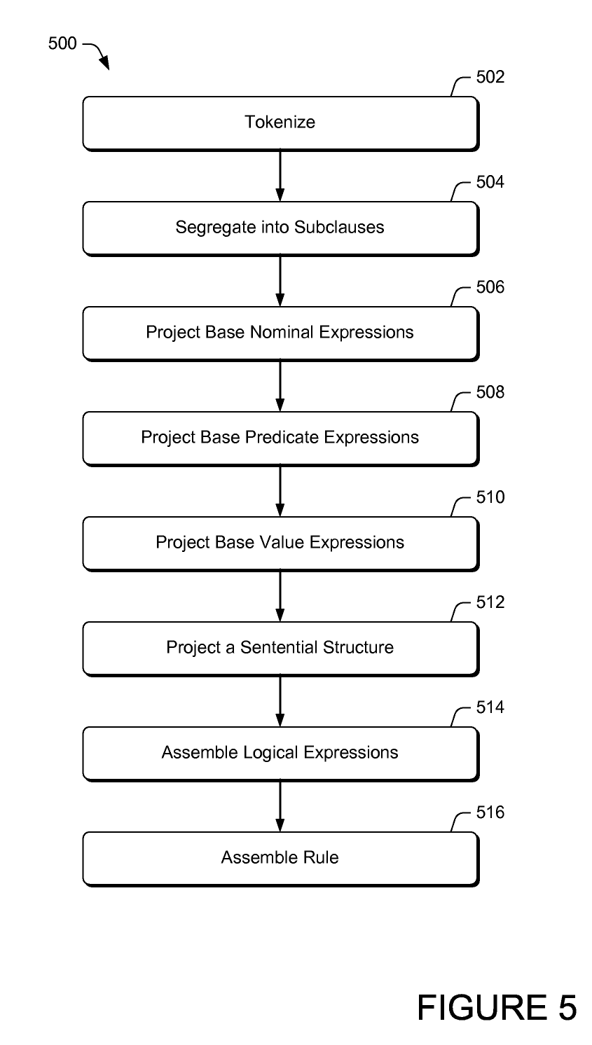

FIGS. 5-14 illustrate exemplary processes that facilitate the conversion of natural language expressions to computational independent model (CIM) rule expressions. The exemplary processes in FIGS. 5-14 are illustrated as a collection of blocks in a logical flow diagram, which represents a sequence of operations that can be implemented in hardware, software, and a combination thereof.

In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are presently described is not intended to be construed as a limitation, and any number of the described blocks can be combined in any order and/or in parallel to implement the process. For discussion purposes, the processes are described with reference to the exemplary CIM phrase tree transformer 102 of FIG. 1, although they may be implemented in other system architectures.

In various embodiments, the processes described in FIGS. 5-14 may be implemented based on the exemplary CIM phrase tree 102 using the CIM phrase tree model 116 described in FIGS. 1 and 2a-2g. Moreover, it will be appreciated that as used in the FIGS. 5-14, token arrays generally refer to an array of tokens that is at least part of a token collection, such as the token collection 206.

FIG. 5 is a flow diagram illustrating an exemplary process for parsing a natural language expression into a computational independent model (CIM) syntax tree representation using a CIM phrase tree model, such as the CIM phrase tree model 116, in accordance with various embodiments.

At block 502, the CIM phrase tree transformer 102 may project each word or sequence of words in a natural language expression that correspond to a known token within a vocabulary of the CIM phrase tree transformer 102 into tokens. In other words, the CIM phrase tree transformer 102 may create a token array, such as token collection 206, that includes tokens, wherein each token includes a word or a sequence of words from the natural language expressions. As further used herein, such a token array that is created from a natural language expression may be referred to as a parent token array.

At block 504, the CIM phrase tree transformer 102 may segregate the tokens into constituent subclauses based on the CIM phrase tree model 116. At block 506, the CIM phrase tree transformer 102 may project one or more base nominal expressions in each subclause based on the CIM phrase tree model 116. At block 508, the CIM phrase tree transformer 102 may project one or more base predicate expressions in each subclause based on the CIM phrase tree model 116.

At block 510, the CIM phrase tree transformer 102 may project one or more base value expressions in each subclause based on the CIM phrase tree model 116. At block 512, the CIM phrase tree transformer 102 may project a sentential structure based on the CIM phrase tree model 116. In one embodiment, the sentential structure is projected to favor functional restrictions.

At block 514, the logical expressions from blocks 504-512 (e.g., base nominal expressions, base predicate expressions, etc.) may be assembled into one or more complex clauses based on the CIM phrase tree model 116.

At block 516, a rule may be assembled by projecting the correct type of intention for the complex clauses based on the CIM phrase tree model 116, where the rule includes a CIM syntax tree representation, such as the CIM syntax tree representation 106. Moreover, the parsed subclauses may be combined with a matrix rule. If the projection of sentential structure fails, the process may be repeated except that the sentential structure is projected without favoring the projection of functional restrictions.

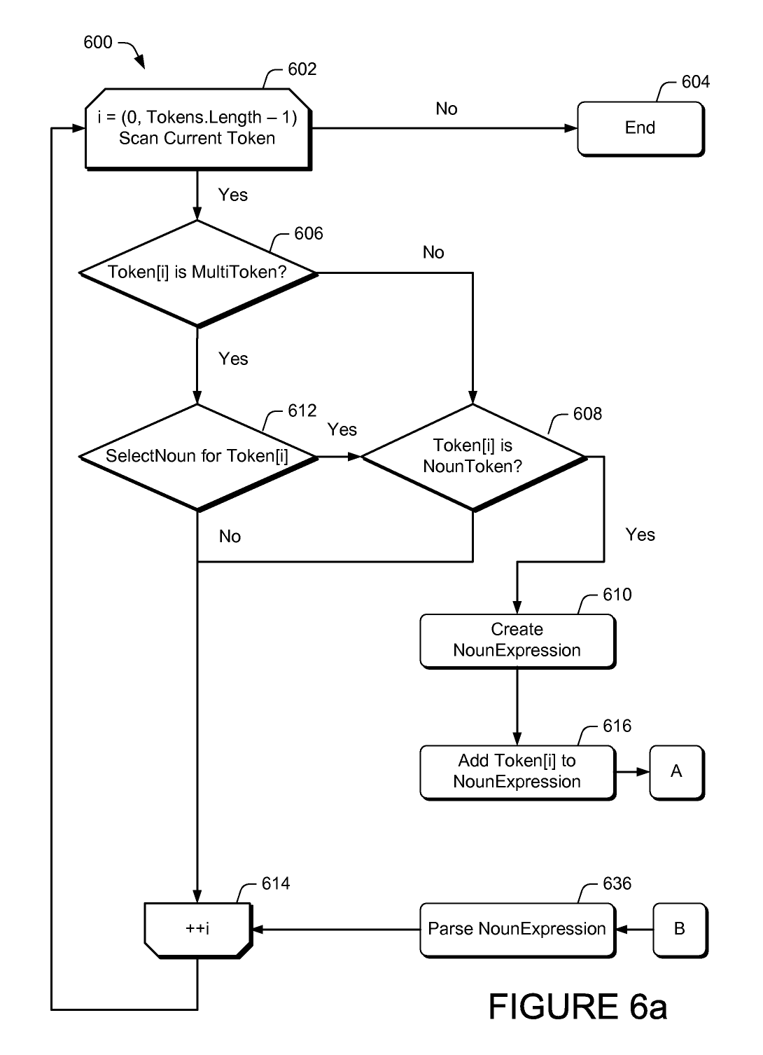

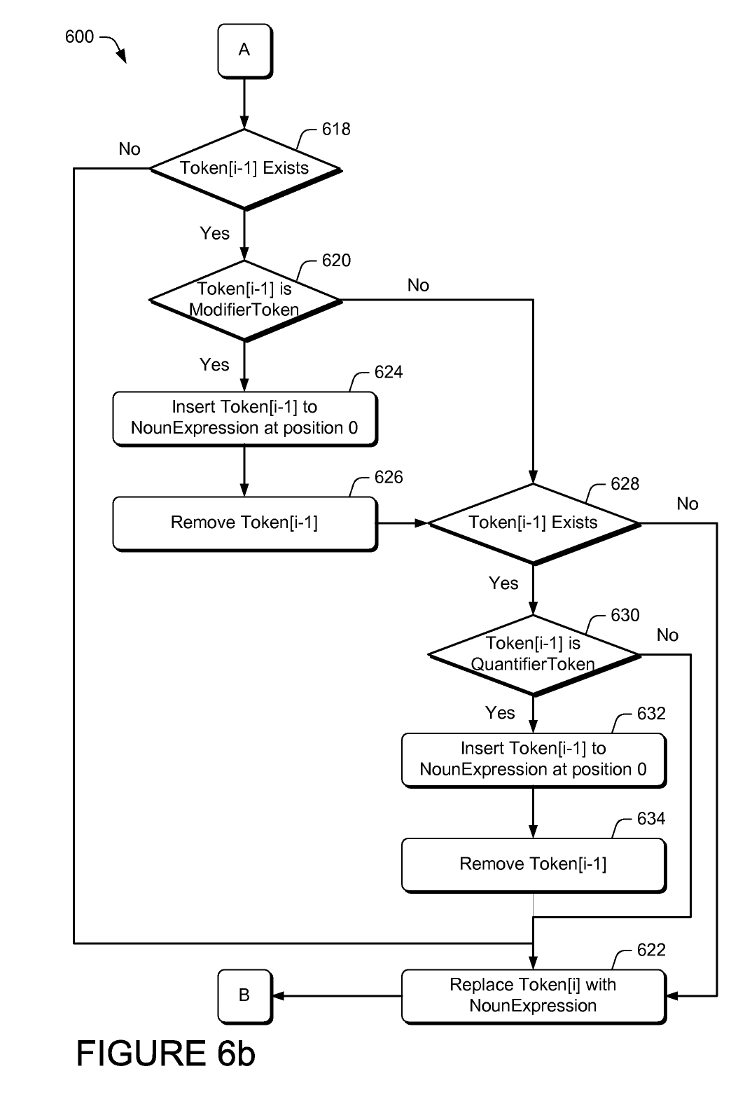

FIGS. 6a and 6b are a flow diagram illustrating an exemplary process 600 for projecting base nominal expressions in accordance with various embodiments. Exemplary process 600 further illustrates block 506 of the process 500.

At block 602, each token in an array of tokens (i.e., the parent token array) may be sequentially scanned by the CIM phrase tree transformer 102 as long as the end of the parent token array is not reached. As described in process 400, the parent token array, such as the token collection 206, may be derived from a natural language expression that includes a plurality of words. If the end of the parent token array is reached, the process 600 may end at block 604. However, as long as the end of the parent token array is not reached, the process may continue to decision block 606.

At decision block 606, the CIM phrase tree transformer 102 may determine whether a current token is a “multi”-token (e.g., the token may map to multiple parts of speech and is context dependent) that resolves to a noun (type) token. If the CIM phrase tree transformer 102 determines that the current token is not a “multi”-token (“no” at decision block 606), the CIM phrase tree transformer 102 may proceed to decision block 608.

At decision block 608, the CIM phrase tree transformer 102 may determined whether the current token is a noun (type) token. If the CIM phrase tree transformer 102 determines at decision block 608 that the current token is a noun (type) token (“yes” at decision block 608), the process 600 may proceed to block 610. At block 610, the CIM phrase tree transformer 102 may create a noun expression based on the current token. However, if the CIM phrase tree transformer 102 determines that the current token is not a noun (type) token (“no” at decision block 608), the process 600 may proceed to incremental block 614. At incremental block 614, the CIM phrase tree transformer 102 may advance to the next token in the parent token array.

Returning to decision block 606, if the CIM phrase tree transformer 102 determines that current token is a “multi”-token (“yes” at decision block 606), the process 600 may further proceed to decision block 612. At decision block 612, the CIM phrase tree transformer 102 may determined whether a noun may be selected for the current token. If the CIM phrase tree transformer 102 determines that a noun may not be selected for the current token (“no” at decision block 612), the process 600 may proceed to incremental block 614. At incremental block 614, the CIM phrase tree transformer 102 may advance to the next token in the parent token array. Subsequently, the process 600 may loop back from block 614 to block 602, where the CIM phrase tree transformer 102 may initiate a scan for the next token. However, if the CIM phrase tree transformer 102 determines that a noun may be selected for the current token (“yes” at decision block 612), the process 600 may proceed to block 608. At block 608, the CIM phrase tree transformer 102 may make the appropriate determination as to proceed to 610 or 614, as described above.

If the process 600 proceeds to block 610, the CIM phrase tree transformer 102 may create a noun expression based the current token. At block 616, the noun token may be added to a token array for the created noun expression (i.e., noun expression token array).

At decision block 618, the CIM phrase tree transformer 102 may determine if a there is a token that immediately precedes the current token in the parent token array. For example, there may be a token that immediately precedes the current token if the current token is not the first token in the parent token array. If the CIM phrase tree transformer 102 determines that there is a token that immediately precedes the current token (“yes” at decision block 618), the process 600 may proceed to decision block 620. However, if the CIM phrase tree transformer 102 determines that there is no token that immediately precedes the current token in the parent token array (“no” at decision block 618), the process 600 may proceed to block 622. At block 622, the CIM phrase tree transformer 102 may replace the noun (type) token in the noun (type) token's position in the parent token array with the created noun expression.

Returning to decision block 620, the CIM phrase tree transformer 102 may determine whether the token immediately preceding the current token (i.e., preceding token) in the parent token array is a modifier token. If the CIM phrase tree transformer 102 determines that the preceding token is a modifier token (“yes” at decision block 620), the process may proceed to block 624. At block 624, the preceding token may be inserted into the noun expression at the start of the noun expression token array. At block 626, the preceding token may be removed from the parent token array. However, if the CIM transformer determines that the preceding token is not a modifier token (“no” at decision block 620), the process may proceed directly to block 628.

At block 628, the CIM phrase tree transformer 102 may determine if there is a token that immediately precedes the current token in the parent token array. For example, there may be a token that immediately precedes the current token if the current token is not the first token in the parent token array. If the CIM phrase tree transformer 102 determines that there is a token that immediately precedes the current token (“yes” at decision block 628), the process 600 may proceed to decision block 630. However, if the CIM phrase tree transformer 102 determines that there is no token that immediately precedes the current token in the parent token array (“no” at decision block 618), the process 600 may proceed to block 622.

At decision block 630, the CIM phrase tree transformer 102 may determine whether the token immediately preceding the current token (i.e., preceding token) in the parent token array is a quantifier token. If the CIM phrase tree transformer 102 determines that the preceding token is a quantifier token (“yes” at decision block 630), the process may proceed to block 632. At block 632, the preceding token may be inserted into the noun expression at the start of the noun expression token array. At block 634, the preceding token may be removed from the parent token array. However, if the CIM transformer determines that the preceding token is not a quantifier token (“no” at decision block 630), the process may proceed directly to block 622. As described above, the CIM phrase tree transformer 102 may replace the noun (type) token in the noun (type) token's position in the parent token array with the created noun expression at block 622 before proceeding to block 636.

At block 636, the created noun expression may be parsed to ensure the validity of the noun expression token array. Following block 636, the process 600 may loop back to incremental block 614, where the CIM phrase tree transformer 102 may advance to the next token in the parent token array. In other words, the next token becomes the current token. Subsequently, the CIM phrase tree transformer 102 may loop back to block 602, where the current token is once again scanned. It will be appreciated that the process 600 may further loop until all the tokens in the parent array are scanned.

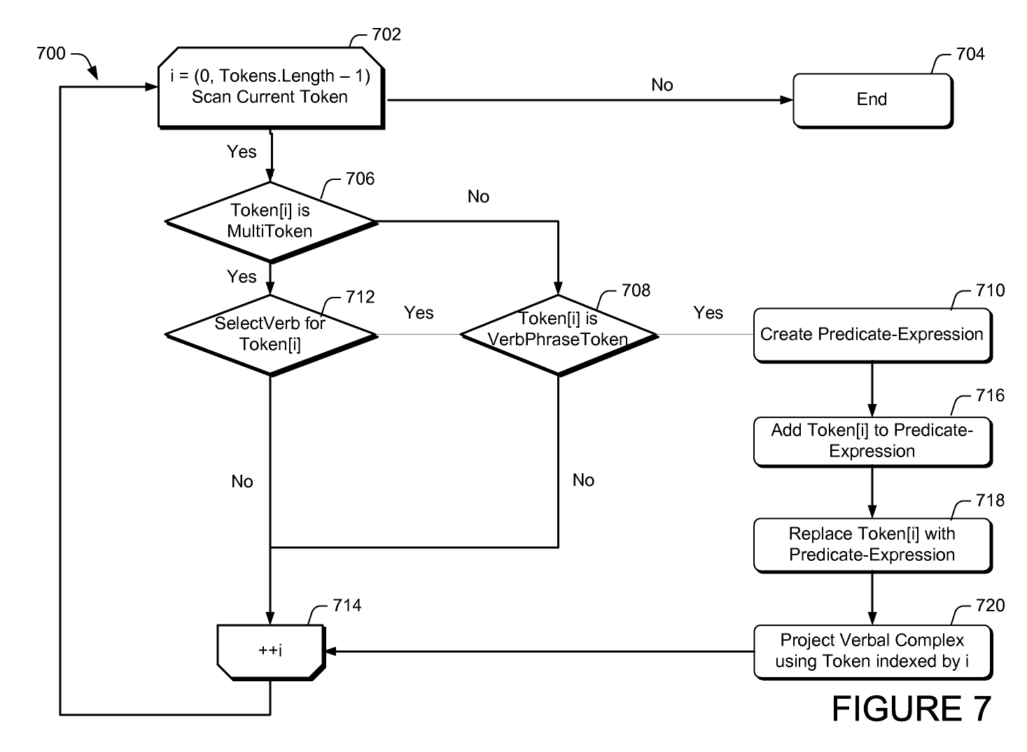

FIG. 7 is a flow diagram illustrating an exemplary process 700 for projecting base predicate expressions in accordance with various embodiments. Exemplary process 700 further illustrates block 508 of the process 500.

At block 702, each token in an array of tokens (i.e., the parent token array) may be sequentially scanned by the CIM phrase tree transformer 102 as long as the end of the parent token array is not reached. As described in process 400, the parent token array may be derived from a natural language expression that includes a plurality of words. If the end of the parent token array is reached, the process 700 may end at block 704. However, as long as the end of the parent token array is not reached, the process may continue to decision block 706.

At decision block 706, the CIM phrase tree transformer 102 may determine whether a current token is a “multi”-token (e.g., the token may map to multiple parts of speech and is context dependent) that resolves to a noun (type) token. If the CIM phrase tree transformer 102 determines that the current token is not a “multi”-token (“no” at decision block 706), the CIM phrase tree transformer 102 may proceed to decision block 708.

At decision block 708, the CIM phrase tree transformer 102 may determined whether the current token is a verb phrase token. If the CIM phrase tree transformer 102 determines at decision block 708 that the current token is a verb phrase token, the process 700 may proceed to block 710. At block 710, the CIM phrase tree transformer 102 may create a predicate expression based on the current token. However, if the CIM phrase tree transformer 102 determines that the current token is not a verb phrase token (“no” at decision block 708), the process 700 may proceed to incremental block 714. At incremental block 714, the CIM phrase tree transformer 102 may advance to the next token in the parent token array.

Returning to decision block 706, if the CIM phrase tree transformer 102 determines that current token is a “multi”-token (“yes” at decision block 706), the process 700 may further proceed to decision block 712. At decision block 612, the CIM phrase tree transformer 102 may determined whether a verb phrase may be selected for the current token. If the CIM phrase tree transformer 102 determines that a verb phrase may not be selected for the current token (“no” at decision block 712), the process 700 may proceed to incremental block 714.

At incremental block 714, the CIM phrase tree transformer 102 may advance to the next token in the parent token array. Subsequently, the process 600 may loop back from block 714 to block 702, where the CIM phrase tree transformer 102 may initiate a scan for the next token. However, if the CIM phrase tree transformer 102 determines that a noun may be selected for the current token (“yes” at decision block 712), the process 700 may proceed to decision block 708. At block 708, the CIM phrase tree transformer 102 may make the appropriate determination as to proceed to 710 or 714, as described above.

If the process 700 proceeds to block 710, the CIM phrase tree transformer 102 may create a predicate expression based the current token. At block 716, the verb token may be added to a token array for the predicate expression (i.e., predicate expression token array). At block 718, the CIM phrase tree transformer 102 may replace the predicate token in the predicate token's position in the parent token array with the created predicate expression. Moreover, if one or more of the verb patterns in Table I, as provided below, are detected, any token preceding the current token in the parent token array may be removed from the array and inserted at the start of the predicate expression token array.

TABLE I
Exemplary Detected Verb Tense Patterns (3^{rd} Person Form)

| Verb Pattern | Example |
|---|---|
| Simple present | Simple present - writes - V-s |
| Simple past | - wrote - V-ed |
| Simple future | will write - will V |
| Simple present | has written - has V-en |
| perfect | |
| Simple past perfect | had written - had V-en |
| Simple future | will have written - will have V-en |
| perfect | |
| Continuous present | is writing - is V-ing |
| Continuous past | was writing - was V-ing |
| Continuous future | will be writing - will be V-ing |
| Continuous present | has been writing - has been V-ing |
| perfect | |
| Continuous past | will have been writing - will have been V-ing |
| perfect | |
| Continuous future | “going-to” future - is going to write - is going to V |
| perfect | |
| Conditional | would write - would V |
| Conditional perfect | would have written - would have V-en |
| Conditional | would have been writing - would have been V-ing |
| progressive perfect | |
| Modal | can/could/may/might/shall/should write - modal V |

While Table I illustrates “positive” verb patterns, the CIM phrase tree transformer 102 may treat the corresponding “negative” verb pattern counterparts to the “positive” verb patterns in a similar manner. In general, the “negative” verb patterns are in the same form as the verb patterns illustrated in Table I, but with “not” injected at the correct location. In the case of the simple present and simple past, the helper verb “do” may be necessary. For instance, the negative simple present is “does not write” and the simple past is “did not write”, but the simple past perfect is “had not written”, the continuous present is “is not writing”, and so on. Accordingly, in various embodiments, the CIM phrase tree transformer 102 may position the negation, such as “not”, as the second element in the verbal complex.

At block 720, the CIM phrase tree transformer 102 may project a verbal complex using the current token. Subsequently, the process 700 may loop back to incremental block 714. At incremental block 714, the CIM phrase tree transformer 102 may advance to the next token in the parent token array. In other words, the next token becomes the current token. Subsequently, the CIM phrase tree transformer 102 may loop back to block 702, where the current token is once again scanned. It will be appreciated that the process 700 may further loop until all the tokens in the parent array are scanned.

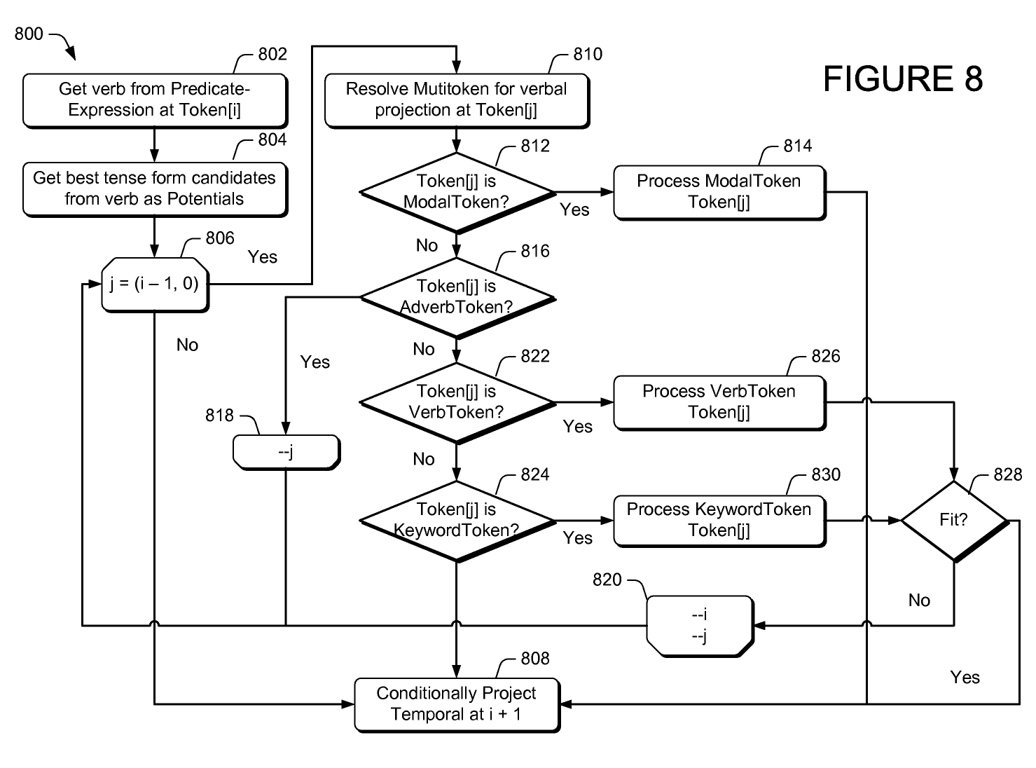

FIG. 8 is a flow diagram illustrating an exemplary process 800 for creating predicate expressions in accordance with various embodiments. Exemplary process 800 further illustrates block 710 of the process 700.

At block 802, the CIM phrase tree transformer 102 may obtain a verb from the current token that includes a predicate expression. At block 804, the CIM phrase tree transformer 102 may obtain the best tense form candidates from the verb as a potential predicate expression. At decision block 806, the CIM phrase tree transformer 102 may determine if there is a token that immediately precedes the current token in the parent token array. For example, there may be a token that immediately precedes the current token (i.e., preceding token) if the current token is not the first token in the parent token array. If the CIM phrase tree transformer 102 determines that there is no token that immediately precedes the current token (“no” at decision block 806), the process 800 may proceed to block 808. At block 808, the CIM phrase tree transformer 102 may conditionally create a temporal predicate expression at a position in the parent token array that is subsequent to the position of the current token in the parent token array.

Return to block 806, if the CIM phrase tree transformer 102 determines that there is a token that immediately precedes the current token in the parent token array (“yes” at decision block 806), the process 800 may proceed to block 810. At block 810, the CIM phrase tree transformer 102 may resolve a “multi”-token for a verbal projection at the preceding token.

At decision block 812, the CIM phrase tree transformer 102 may determine whether the preceding token is a modal token. If the CIM phrase tree transformer 102 determines that the preceding token is a modal token, (“yes” at decision block 812), process may proceed to block 814. At block 814, the CIM phrase tree transformer 102 may process the preceding token as a modal token at block 814. Following block 814, the process 800 may proceed to block 808.

However, if the CIM phrase tree transformer 102 determines that the preceding token is not a modal token (“no” at decision block 812), the process 800 may proceed to decision block 816. At decision block 816, the CIM phrase tree transformer 102 may determine whether the preceding token is an adverb token. If the CIM phrase tree transformer 102 determines that the preceding token is an adverb token (“yes” at block 816), the CIM phrase tree transformer 102 may move to incremental block 818. At incremental block 818, the CIM phrase tree transformer 102 may move to a token that immediately precedes the preceding token in the parent token array. Following block 818, the CIM phrase tree transformer 102 may loop back to decision block 806.

However, if the CIM phrase tree transformer 102 determines that the preceding token is not an adverb token (“no” at block 816), the CIM phrase tree transformer 102 may proceed to decision block 822. At decision block 822, the CIM phrase tree transformer 102 may determine whether the preceding token is a verb token. If the CIM phrase tree transformer 102 determines that the preceding token is not a verb token (“no” at decision block 822), the process 800 may proceed to decision block 824.

However, if the CIM phrase tree transformer 102 determines that the preceding token is a verb token (“yes” at decision block 822), the process 800 may proceed to block 826. At block 826, the CIM phrase tree transformer 102 may process the preceding token as a verb token. Following block 826, the process 800 may proceed to block 828. At block 828, the process 800 may determine whether the processed preceding token (e.g., verb token) fits the predicate impression.

If the CIM phrase tree transformer 102 determines that the processed preceding token does not fit the predicate expression (“no” at decision block 828), the process may proceed to incremental block 820. At incremental block 820, the CIM phrase tree transformer 102 may move to a token that are two tokens away from the preceding token in the parent token array. Following block 820, the CIM phrase tree transformer 102 may loop back to decision block 806. Once again, at decision block 806, the process 800 may be looped again.

However, if the CIM phrase tree transformer 102 determines that the processed preceding token doe fit the predicate expression (“yes” at decision block 828), the process may proceed to incremental block 808.

Returning to decision block 824, the CIM phrase tree transformer 102 may determine whether the preceding token is a keyword token. If the CIM phrase tree transformer 102 determines that the preceding token is not a keyword token (“no” at decision block 824), the process 800 may proceed to the block 808. At block 808, the CIM phrase tree transformer 102 may conditionally create a temporal predicate expression at a position in the parent token array that is subsequent to the position of the current token in the parent token array.

However, if the CIM phrase tree transformer 102 determines that the preceding token is a keyword token (“yes” at decision block 824), the process 800 may proceed to block 830. At block 830, the CIM phrase tree transformer 102 may process the preceding token as a keyword token. Following block 830, the process 800 may proceed to block 828. At block 828, the process 800 may determine whether the processed preceding token (e.g., keyword) fits the predicate impression. Once again, at block 808, the CIM phrase tree transformer 102 may conditionally create a temporal predicate expression at a position in the parent token array that is subsequent to the position of the current token in the parent token array.

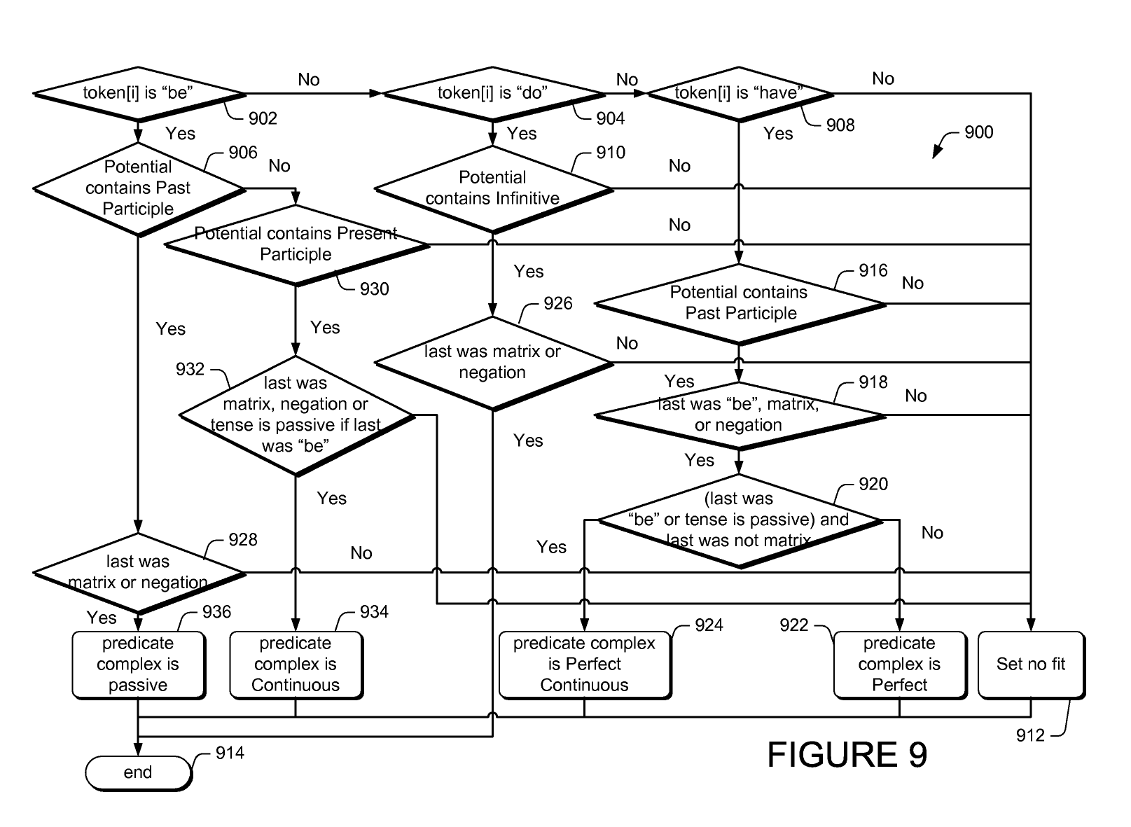

FIG. 9 is a flow diagram illustrating an exemplary process 900 for processing helper verbs in a predicate complex in accordance with various embodiments.

At decision block 902, the CIM phrase tree transformer 102 may determine whether a token[i] (i.e., current token) in a parent token array is the verb “be”. If the CIM phrase tree transformer 102 determines that the current token is not the verb “be” (“no” at decision block 902), the process 900 may continue to decision block 904. However, if the CIM phrase tree transformer 102 determines that the current token is the verb “be” (“yes” at decision block 902), the process 900 may continue to decision block 906.

At decision block 904, the CIM phrase tree transformer 102 may determine whether the current token is the verb “do”. If the CIM phrase tree transformer 102 determines that the current token is not the verb “do” (“no” at decision block 904), the process 900 may continue to decision block 908. Otherwise, if the CIM phrase tree transformer 102 determines that the current token is the verb “do” (“yes” at decision block 904), the process 900 may continue to decision block 910.

Returning to decision block 908, the CIM phrase tree transformer 102 may determines whether the current token is the verb “have”. If the CIM phrase tree transformer 102 determines that the current token is not the verb “have” (“no” at decision block 908), the process 900 may proceed to block 912. At block 912, the CIM phrase tree transformer 102 may determined that the current token does not fit into a predicate expression tense. Subsequently, the process 900 may end at block 914. However, if the CIM phrase tree transformer 102 determines that the current token is the verb “have” (“yes” at decision block 910), the process 900 may proceed to decision block 916.

At decision block 916, the CIM phrase tree transformer 102 may determine whether a potential verb (e.g., a verbal construction that states something is possible or probable) associated with the current token contains a past participle. If the CIM phrase tree transformer 102 determines that the potential verb does not contain a past participle (“no” at decision block 916), the process 900 may proceed to block 912. At block 912, the CIM phrase tree transformer 102 may determined that the current token does not fit into a predicate expression tense. Subsequently, the process 900 may end at block 914. However, if the CIM phrase tree transformer 102 determines that the potential verb does contain a past participle, the process 900 may proceed to decision block 918.

At decision block 918, the CIM phrase tree transformer 102 may determine whether a last token, that is, a token that immediately precedes the current token in the parent array, was the verb “be”, a matrix verb, or a negation. If the CIM phrase tree transformer 102 determines that the last token does not meet these criteria (“no” at decision block 916), the process 900 may proceed to block 912. At block 912, the CIM phrase tree transformer 102 may determined that the current token does not fit into a predicate expression tense. Subsequently, the process 900 may end at block 914. However, if the CIM phrase tree transformer 102 determines that the last token meets these criteria (“yes” at decision block 918), the process 900 may proceed to decision block 920.

At decision block 920, the CIM phrase tree transformer 102 may determine whether the last token in the parent array was the verb “be”, or that the last token has a passive tense, and the last token was not a matrix. If the CIM phrase tree transformer 102 determines that the last token does not meet these criteria, (“no” at decision block 918), the process 900 may proceed to block 922. At block 922, the CIM phrase tree transformer 102 may designate a predicate complex associated with the current token as having a perfect tense. Subsequently, the process 900 may end at block 914. However, if the CIM phrase tree transformer 102 determines that the last token does meet these criteria, (“yes” at decision block 918), the process 900 may proceed to block 924. At block 924, the CIM phrase tree transformer 102 may designate a predicate complex associated with the current token as having a perfect continuous tense. Subsequently, the process 900 may end at block 914.

Returning to decision block 910, the CIM phrase tree transformer 102 may determine whether a potential associated with the current token contains an infinitive. If the CIM phrase tree transformer 102 determines that the potential does not contain an infinitive (“no” at decision block 910), the process 900 may proceed to block 912. At block 912, the CIM phrase tree transformer 102 may determined that the current token does not fit into a predicate expression tense. However, if the CIM phrase tree transformer 102 determines that the potential does contain an infinitive (“yes” at decision block 910), the process 900 may continue to decision block 926.

At decision block 926, the CIM phrase tree transformer 102 may determine whether the last token was a matrix verb or a negation. If the CIM phrase tree transformer 102 determines that the last token does not meet these criteria (“no” at decision block 924), the process 900 may proceed to block 912. At block 912, the CIM phrase tree transformer 102 may determined that the current token does not fit into a predicate expression tense. Subsequently, the process 900 may end at block 914. However, if the CIM phrase tree transformer 102 determines that the last token meets these criteria (“yes” at decision block 926), the process 900 may terminate at block 914.

Returning to decision block 906, the CIM phrase tree transformer 102 may determine whether a potential associated with the current token contains a past participle. If the CIM phrase tree transformer 102 determines that the potential doe contain a past participle (“yes” at decision block 906), the process 900 may proceed to decision block 928. However, if the CIM phrase tree transformer 102 determines that the potential doe contain a past participle (“no” at decision block 906), the process 900 may proceed to decision block 930.

At decision block 930, the CIM phrase tree transformer 102 may determine whether the last token was a matrix verb, a negation, or if the tense of the last token is passive when the last token was “be”. If the CIM phrase tree transformer 102 determines that the last token does not meet these criteria (“no” at decision block 930), the process 900 may proceed to block 912. At block 912, the CIM phrase tree transformer 102 may determined that the current token does not fit into a predicate expression tense. Subsequently, the process 900 may end at block 914. However, if the CIM phrase tree transformer 102 determines that the last token meets these criteria (“yes” at decision block 928), the process 900 may proceed to decision block 930.

At decision block 932, the CIM phrase tree transformer 102 may determine whether the last token was a matrix verb, a negation, or whether the tense of the current token is passive if the last token was “be”. If the CIM phrase tree transformer 102 determines that the last these criteria are not met (“no” at decision block 932), the process 900 may proceed to block 912. At block 912, the CIM phrase tree transformer 102 may determined that the current token does not fit into a predicate expression tense. Subsequently, the process 900 may end at block 914. However, if the CIM phrase tree transformer 102 determines that these criteria are met (“yes” at decision block 932), the process 900 may proceed to block 934. At block 934, the CIM phrase tree transformer 102 may designate a predicate complex associated with the current token as having a continuous tense. Subsequently, the process 900 may end at block 914.

Returning to 928, the CIM phrase tree transformer 102 may determine whether the last token was a matrix verb or a negation. If the CIM phrase tree transformer 102 determines that the last these criteria are not met (“no” at decision block 928), the process 900 may proceed to block 912. At block 912, the CIM phrase tree transformer 102 may determined that the current token does not fit into a predicate expression tense. Subsequently, the process 900 may end at block 914. However, if the CIM phrase tree transformer 102 determines that these criteria are met (“yes” at decision block 928), the process 900 may proceed to block 936. At block 936, the CIM phrase tree transformer 102 may designate a predicate complex associated with the current token as having a passive tense. Subsequently, the process 900 may end at block 914.

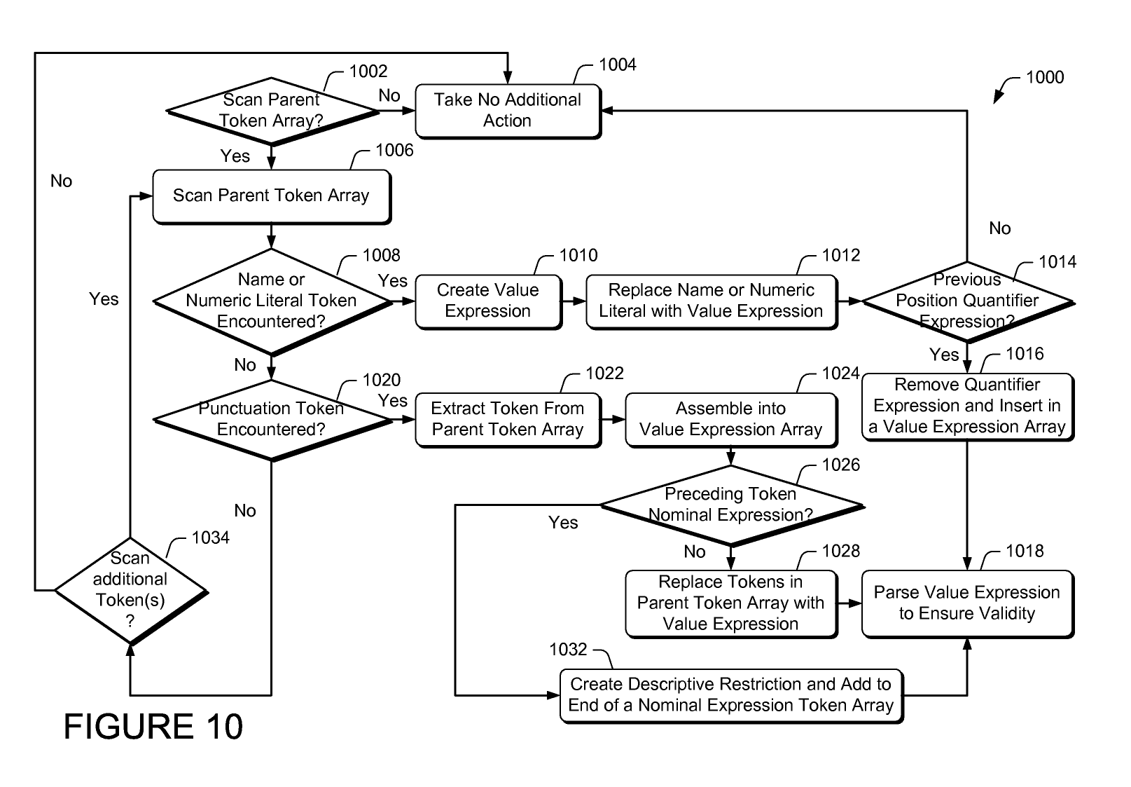

FIG. 10 is a flow diagram illustrating an exemplary process 1000 for projecting value expressions in accordance with various embodiments. Exemplary process 1000 further illustrates block 510 of the process 500.

At decision block 1002, the CIM phrase tree transformer 102 may determine whether a parent token array is scanned. According to various embodiments, if the parsing occurs at the level of a value expression and a value expression token array has a count of one, no action is taken on the parent token array. Moreover, if the parsing occurs at the level of a value expression and the value expression token has a value expression of two, and if the first token is a quantifier and the second token is a name or a numeric literal, no action is taken on the parent token array. In another instance, if the first token is the “that” keyword and the second token is either a simple or complex interrogative or a simple or complex proposition, no action is taken on the parent token array. Accordingly, if the CIM phrase tree transformer 102 ascertains that any of the above conditions exist, the CIM phrase tree transformer 102 may determine that a scan of the parent token array is not necessary (“no” at decision block 1002), the process 1000 may move to block 1004, where the CIM phrase tree transformer 102 may take no action.

However, if the CIM phrase tree transformer 102 determines that the above mentioned conditions do not exist, the process 1000 may continue to block 1006. At block 1006, the parent token array is scanned. In other words, the CIM phrase tree transformer 102 may examine each token in the parent token array. At decision block 1008, the CIM phrase tree transformer 102 may determine whether a name or a numeric literal is encountered as it scans each token. If the CIM phrase tree transformer 102 determines that a name token or a numeric literal token is encountered (“yes” at decision block 1008), the process 1000 may proceed to block 1010.

At block 1010, the CIM phrase tree transformer 102 may create a value expression based on the name or the numeric literal. At block 1012, the name token or the numeric literal may be further added to a created value expression token array, and the value expression may replace the name or the numeric literal in the parent token array.

At decision block 1014, the CIM phrase tree transformer 102 may determine whether a quantifier token is in a position that is previous to the position of the name token/numeric token in the parent token array. If the CIM phrase tree transformer 102 determines that a quantifier token is in the previously position (“yes” at decision block 1014), the process 1000 may proceed to block 1016. At block 1016, the CIM phrase tree transformer 102 may remove the quantifier token from its position in the parent token array. Moreover, the CIM phrase tree transformer 102 may further insert the quantifier token into the value expression at the start of the value expression token array. At block 1018, the value expression may be further parsed to ensure the validity of value expression token array. However, If the CIM phrase tree transformer 102 determines that no quantifier token is in the previously position (“no” at decision block 1014), the process 1000 may proceed to block 1004, where no further action related to the encountered name token/numeric literal token may be performed.

Returning to decision block 1008, if the CIM phrase tree transformer 102 determines that no name token or numeric literal token is encountered (“no” at decision block 1008), the process 1000 may proceed to decision block 1020. At decision block 1020, the CIM phrase tree transformer 102 may determine whether an opening punctuation token (e.g., an opening quote or an opening parenthesis, etc.) is encountered. If the CIM phrase tree transformer 102 determines that a punctuation token is encountered (“yes” at decision block 1020), the process 1000 may proceed to block 1022.

At block 1022, tokens following the punctuation token may be scanned until a matching closing punctuation token (e.g., matching quote, closing parenthesis, etc.) is encountered. At block 1024, the set of matching punctuation tokens (e.g., quotes, parentheses, etc.) and the intervening tokens are then assembled into a newly created value expression token array.

At decision block 1026, the CIM phrase tree transformer 102 may determine whether a token that precedes the opening punctuation in the parent token array (i.e., preceding token) is a nominal expression. If the CIM phrase tree transformer 102 determines that the preceding token is a nominal expression (“yes” at decision block 1026), the matching punctuation tokens (e.g., matching quotes, parentheses, etc.) and the intervening tokens may be replaced by the single value expression. Moreover, the value expression may be added to the token array of a newly created descriptive restriction and the descriptive restriction may be added to the end of the nominal expression token array. Further, the matching punctuation tokens and all the intervening tokens may be deleted from the parent token array. Subsequently, at block 1018, the value expression may be further parsed to ensure the validity of value expression token array.

Returning to decision block 1026, If the CIM phrase tree transformer 102 determines that the preceding token is not a nominal expression (“no” at decision block 1026), the CIM phrase tree transformer 102 may replace the opening punctuation token (e.g., the open quote, open parenthesis, etc.) and the intervening tokens in the parent token array may be replaced in the parent token array by the value expression. In some embodiments, the CIM phrase tree transformer 102 may encounter nested parenthetical. In such embodiments, all tokens including the nested parenthetical elements may be moved en masse into the value expression. Subsequently, at block 1018, the value expression may be further parsed to ensure the validity of value expression token array.

Returning to decision block 1020, if CIM phrase tree transformer 102 determines that a punctuation token is not encountered (“no” at decision block 1020), the process 1000 may proceed to decision block 1034. At decision block 1034, the CIM phrase tree transformer 102 may determine whether additional tokens in the parent token array should be scanned. For example, in some embodiments, the CIM phrase tree transformer 102 may be configured scan each token in the parent token array sequentially until all the tokens are scanned. If the CIM phrase tree transformer 102 determines that one or more additional tokens of the parent token array should be scanned (“yes” at decision block 1034), the process 1000 may loop back to block 1006. However, if the CIM phrase tree transformer 102 determines that no additional tokens should be scanned (“no” at decision block 1034), the process 1000 may proceed to block 1004, where no additional action is taken by the CIM phrase tree transformer 102.

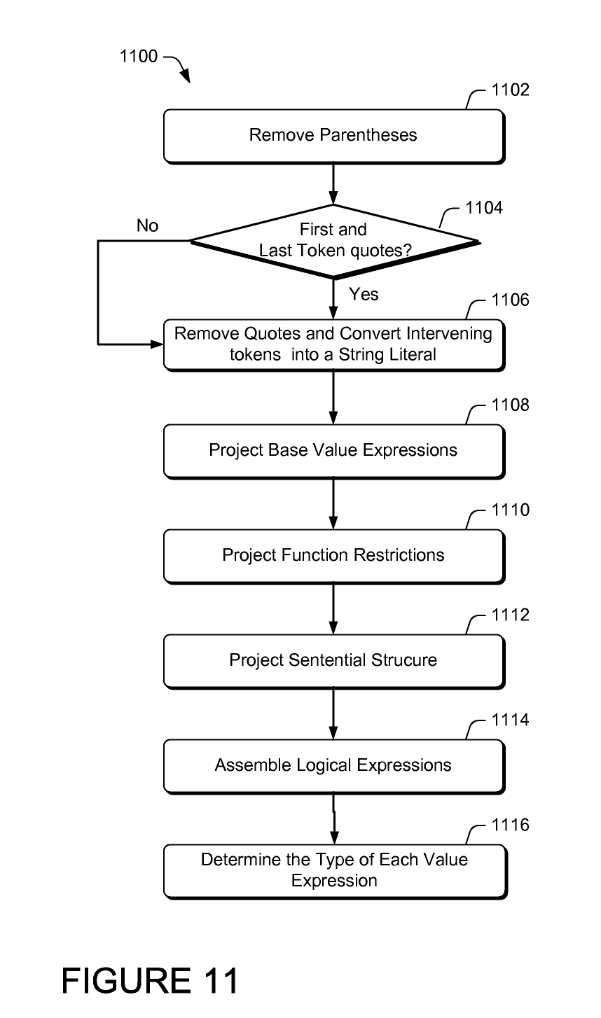

FIG. 11 is a flow diagram illustrating an exemplary process 1100 for parsing value expressions in accordance with various embodiments. Exemplary process 1100 further illustrates block 1018 of the process 1000.

At block 1102, the CIM phrase tree transformer 102 may remove any parentheses from the ends of the value expression token array in a pair-wise fashion. At block 1104, the CIM phrase tree transformer 102 may determine whether the first and last tokens in the value expression token array are quotes. If the CIM phrase tree transformer 102 determines that the first and last tokens are quotes (“yes”) at decision block 1104, the process 1100 may proceed to block 1106. At block 1106, the first and last tokens are removed and the intervening tokens are converted into a string literal. The process 1100 may then proceed to block 1108. However, if the CIM phrase tree transformer 102 determines that the first and last tokens are not quotes (“no”) at decision block 1104, the process 1100 may proceed directly to block 1108.

At block 1108, the CIM phrase tree transformer 102 may project one or more base value expressions. For example, the projection of the base values expressions may be a recursive call to assemble the one or more value expressions. At block 1110, the CIM phrase tree transformer 102 may project one or more function restrictions. At block 1112, the CIM transformer 1112 may project a sentential structure that facilitates the projection of functional restrictions. At block 1114, the CIM phrase tree transformer 102 may assemble the one or more logical expressions from the block 1108 (e.g., base value expressions).

At block 1116, the CIM phrase tree transformer 102 may determine the type of each base value expression so that the base value expression as a whole projects a definite nominal type. For instances, in the case of literals, the type projected may correspond to the literal. Likewise, for functions and aggregations, the type may be a type that is projected by the function or the aggregation. It will be appreciated that if one of the value expression is preceded by a quantifier, the quantifier “the” is provided as the quantifier.

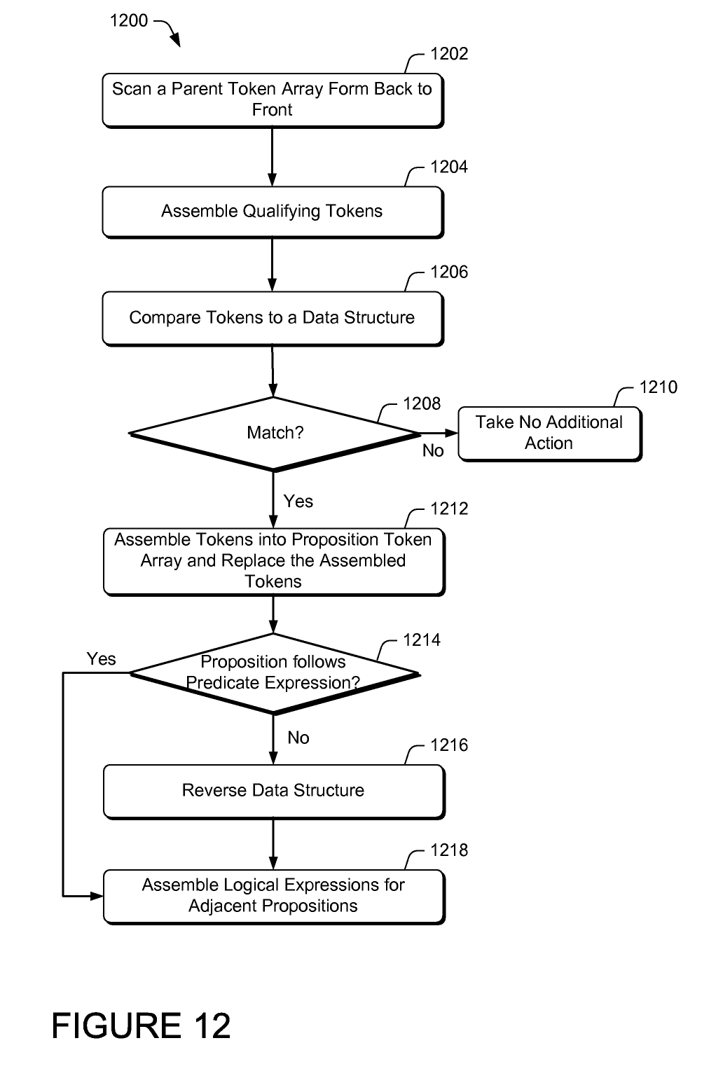

FIG. 12 is a flow diagram illustrating an exemplary process for projecting sentential structure in accordance with various embodiments. Exemplary process 1200 further illustrates block 512 of the process 500.

At block 1202, the CIM phrase tree transformer 102 may scan a parent token array. In one embodiment, the parent token array may be scanned from back to front, that is, in ascending order. At block 1204, the CIM phrase tree transformer 102 may select nominal expressions, predicate expressions, propositions, interrogatives (which may be treated as nominal expressions), and other connecting phrases up to the maximum number of tokens. The maximum number of tokens may be defined by a fact type with the largest number of elements. The CIM phrase tree transformer 102 may assemble a collection of these tokens.

At block 1206, the types of tokens in the collection may be compared to a data structure suitable for rapid pattern matching of the assembled tokens to available fact types. At decision block 1208, if the CIM phrase tree transformer 102 determines that a match is not encountered (“no” at decision block 1208), the process 1200 may proceed to block 1210, where the CIM phrase tree transformer 102 may take no additional action with respect to the collection of tokens.

However, if the CIM phrase tree transformer 102 determines that a match is encountered (“yes” at decision block 1208), the process 1200 may proceed to decision block 1212. At decision block 1212, the CIM phrase tree transformer 102 may assemble the tokens into a token array of newly created proposition. Further, the CIM phrase tree transformer 102 may also replace the assembled tokens in the parent token array with the proposition. Subsequently, the process 1200 may proceed to decision block 1214.

At decision block 1214, the CIM phrase tree transformer 102 may determine whether at least one pattern that includes a predicate expression that projects the passive voice of a verb and followed by a preposition “by” exists. If the CIM phrase tree transformer 102 determine that the conditions at decision block 1214 are fulfilled (“yes” at decision block 1214), the CIM phrase tree transformer 102 may reversed the order in which the assemble tokens are looked up in the data structure as between the nominal expression that precedes the predicate expression and the nominal expression that follows the preposition “by”. For example, the general patterns may be as follows: (1) some NE1 V-s some NE2 at some NE3 . . . ; and (2) some NE2 is V-en by some NE1 at some NE3 . . . . Subsequently, once all of the propositions are found during a pass through of the tokens, the process 1200 may proceed to block 1216. However, if the conditions at decision block 1214 are not fulfilled (“no” at decision block 1214), the process 1200 may proceed directly to block 1218.

At block 1218, the CIM phrase tree transformer 102 may assemble logical expressions. The logical expressions may be assembled such that two adjacent propositions and/or interrogatives are separated by “and” or “or”. In various embodiments, the two sentential expressions (proposition and/or interrogative) and the connective “and”/“or” may be added to a complex proposition or a complex interrogative depending on whether or not one or more interrogatives is included. The three elements may then be further replaced by the complex proposition (hosting two propositions) or the complex interrogative (hosting one or more interrogatives). This process may be repeated for increasingly smaller fragment counts until all variations in length and token sequence are resolved.

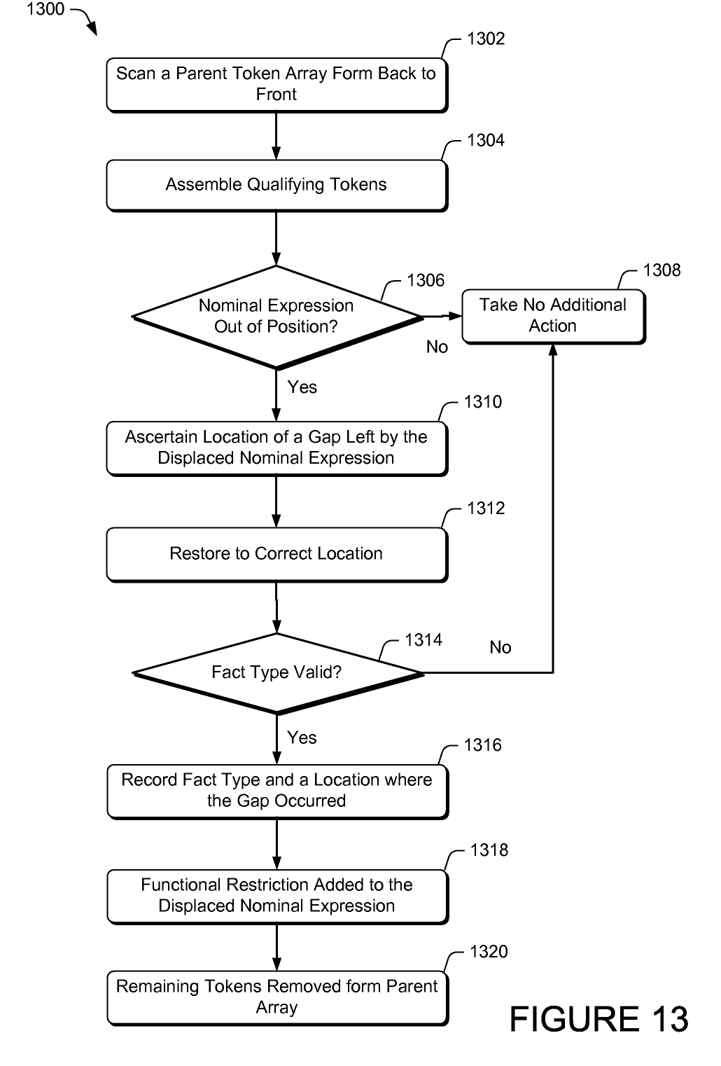

FIG. 13 is a flow diagram illustrating an exemplary process for projecting functional restrictive structure in accordance with various embodiments. Exemplary process 1300 further illustrates block 512 of the process 500.

At block 1302, the CIM phrase tree transformer 102 may scan a parent token array. In one embodiment, the parent token array may be scanned from back to front, that is, in ascending order. At block 1304, the CIM phrase tree transformer 102 may select nominal expressions, predicate expressions, propositions, interrogatives (which may be treated as nominal expressions), and other connecting phrases up to the maximum number of tokens. The maximum number of tokens may be defined by a fact type with the largest number of elements. The CIM phrase tree transformer 102 may assemble a collection of these tokens.

At decision block 1306, the CIM phrase tree transformer 102 may determine whether a nominal expression is out of position and is at the head of the sequence. This nominal expression may or may not be followed by the complementizer “that”. A used herein, a complementizer is a word that introduces a clause that acts as a complement. If the CIM phrase tree transformer 102 determines that no nominal expression is out of sequence (“no” at decision block 1306), the process 1300 may proceed to block 1308, where the CIM phrase tree transformer 102 may take no additional action with respect to the collection of tokens.

However, if the CIM phrase tree transformer 102 determines that a nominal expression is out of sequence (“yes” at decision block 1306), the process 1300 may proceed to block 1310. At block 1310, the CIM phrase tree transformer 102 may perform a look up to discover the location of the gap left by the displaced nominal expression. At block 1312, the CIM phrase tree transformer 102 may restore the nominal expression to its correct location. At decision block 1314, the CIM phrase tree transformer 102 may determine whether the fact type included in the nominal expression is valid. Further, if the preposition “by” occurs within the sequence of tokens, the passive is tested by reversing the nominal expression immediately preceding the predicate expression and the nominal expression immediately following the preposition “by”, even if either nominal expression was the displaced nominal expression. The general patterns are as follows: (1) the NE1 [that] V-s to some NE2 at some NE3 . . . ; (2) the NE1 [that] some NE2 is V-en by {at some NE3} . . . ; (3) the NE [symbol] 1 is V-ing to some NE [symbol] 2 at some NE3 . . . ; (4) the NE1 [that] some NE2 is Ving at some NE3; (5) the NE1 that is V-ing to some NE2 at some NE3; (6) the NE1 [that] some NE2 is being V-en to by at some NE3; (7) the NE2 [that] the NE1 V-s to at some NE3; (8) the NE2 V-en to by some NE1 at some NE3; (9) the NE2 V-ed to by some NE1 at some NE3; (10) the NE2 [that] the NE1 V-s to at some NE3; (11) the NE1 that V-s to some Y at some NE3; (12) the NE2 TO BE V-en to by some NE1 at some NE3; (13) the NE2 that is V-en to by some NE1 at some NE3; and (14) the NE2 TO BE V-en/V-ing.

Moreover, in instances where “TO BE” occurs, it should be noted that the verb “is” is absent in the surface forms, but may be included in order to find the fact type. Thus, for those two cases, the verb “to be” may be inserted to find the correct fact type. Also note that in those cases where the fact type is marked as a mathematical function form, a mathematical function is projected instead of a functional restriction. This process is repeated for increasingly smaller fragment counts until all variations in length and token sequence are resolved.

Accordingly, if the CIM phrase tree transformer 102 determines that the fact type is not valid (“no” at decision block 1314), the process 1300 may proceed to block 1308, where the CIM phrase tree transformer 102 may take no additional action with respect to the collection of tokens. However, if the CIM phrase tree transformer 102 determines that the fact type is valid (“yes” at decision block 1314), the process 1300 may proceed to block 1316. At block 1316, the CIM phrase tree transformer 102 may create a functional restriction expression that records the fact type and where the gap occurs. At block 1318, the CIM phrase tree transformer 102 may add the functional restriction to the displaced nominal expression. At block 1320, the CIM phrase tree transformer 102 may remove the remaining tokens from the parent token array.

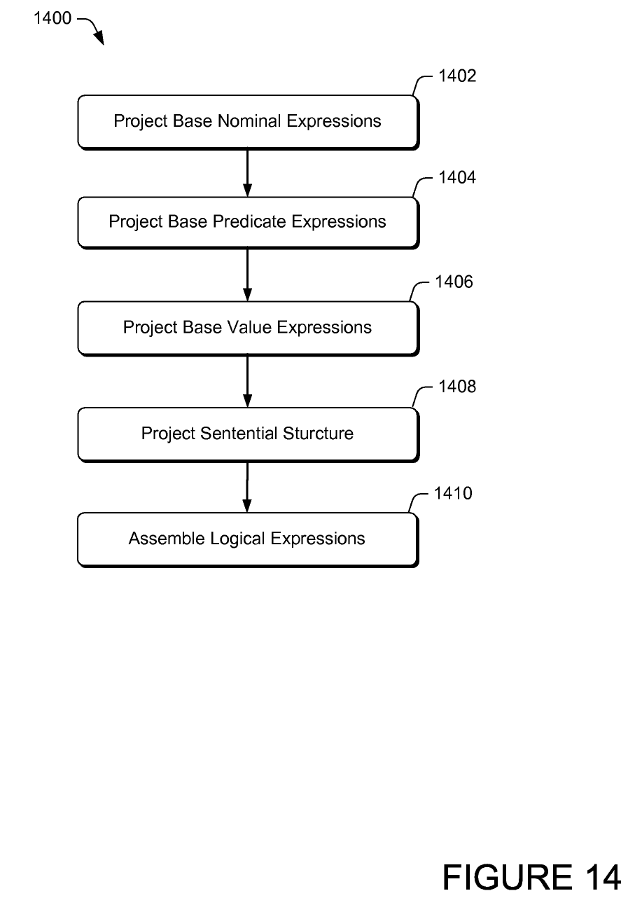

FIG. 14 is a flow diagram illustrating an exemplary process 1400 for parsing one or more conditional subclauses and/or one or more sentential expressions in accordance with various embodiments.

At block 1402, the CIM phrase tree transformer 102 may project one or more base nominal expressions. At block 1404, the CIM phrase tree transformer 102 may project one or more base value expression.

At block 1404, the CIM phrase tree transformer 102 may project one or more base predicate expressions. At block 1406, the CIM phrase tree transformer 102 may project one or more base value expressions. At block 1408, the CIM phrase tree transformer 102 may project a sentential structure. In various embodiments, the sentential structure may be projected to favor the projection of functional restrictions. At block 1410, the CIM phrase tree transformer 102 may assemble the logical expressions from blocks 1404-1408 (e.g., base predicate expressions, base value expressions, etc.) into one or more complex clauses.

It will be appreciated that in an instance of a given subclause, the initial keyword “given” must be present. Moreover, it is possible that only a nominal expression follows the “given” keyword. In such an instance, it is assumed that an expression like “given some thing” is an abbreviation of the sentential clause “given [that] something exists”. In an instance of an event clause, the initial keyword “upon” must be present. Moreover, the only valid expression following this initial keyword is a nominal expression. Such a nominal expression may be complex (i.e., have a functional restriction). Further, in the instance of a conditional subclause, the initial keyword “if” must be present. In such an instance, the expression following the initial keyword must be a complex proposition or a complex interrogative.

### Exemplary Computing Environment

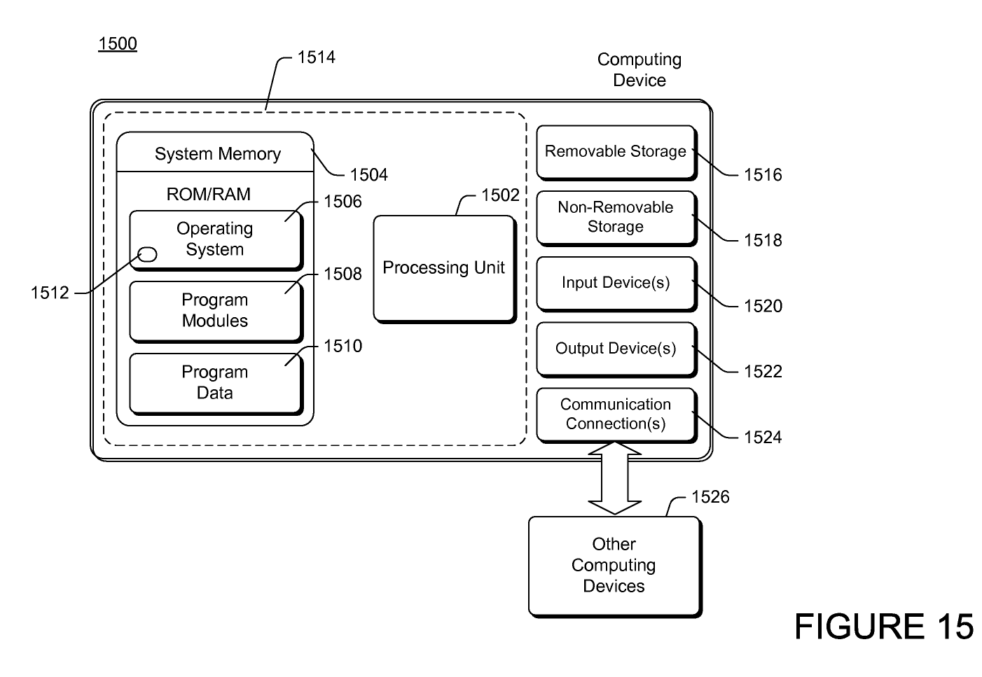

FIG. 15 illustrates a representative a computing device 1500 that may be used to implement a computational independent model (CIM) phrase tree model transformer described herein. For example, the CIM phrase tree transformer 102 (FIG. 1) may be implemented on the representative computing device 1500. However, it will readily be appreciated that the various embodiments of CIM phrase tree model transformer may be implemented in other computing devices, systems, and environments. The computing device 1500 shown in FIG. 15 is only one example of a computing device, and is not intended to suggest any limitation as to the scope of use or functionality of the computer and network architectures. Neither should the computing device 1500 be interpreted as having any dependency or requirement relating to any one or combination of components illustrated in the example computing device.

In a very basic configuration, computing device 1500 typically includes at least one processing unit 1502 and system memory 1504. Depending on the exact configuration and type of computing device, system memory 1504 may be volatile (such as RAM), non-volatile (such as ROM, flash memory, etc.) or some combination of the two. System memory 1504 typically includes an operating system 1506, one or more program modules 1508, and program data 1510. The operating system 1506 may include a component-based framework 1512 that supports components (including properties and events), objects, inheritance, polymorphism, reflection, and provides an object-oriented component-based application programming interface (API), such as, but by no means limited to, that of the .NET™ Framework manufactured by the Microsoft Corporation, Redmond, Wash. The device 1500 is of a very basic configuration demarcated by a dashed line 1514. Again, a terminal may have fewer components but will interact with a computing device that may have such a basic configuration.

Computing device 1500 may have additional features or functionality. For example, computing device 1500 may also include additional data storage devices (removable and/or non-removable) such as, for example, magnetic disks, optical disks, or tape. Such additional storage is illustrated in FIG. 15 by removable storage 1516 and non-removable storage 1518. Computer storage media may include volatile and nonvolatile, removable and non-removable media implemented in any method or technology for storage of information, such as computer readable instructions, data structures, program modules, or other data. System memory 1504, removable storage 1516 and non-removable storage 1518 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1500. Any such computer storage media may be part of device 1500. Computing device 1500 may also have input device(s) 1520 such as keyboard, mouse, pen, voice input device, touch input device, etc. Output device(s) 1522 such as a display, speakers, printer, etc. may also be included. These devices are well known in the art and are not discussed at length here.

Computing device 1500 may also contain communication connections 1524 that allow the device to communicate with other computing devices 1526, such as over a network. These networks may include wired networks as well as wireless networks. Communication connections 1524 are some examples of communication media. Communication media may typically be embodied by computer readable instructions, data structures, program modules, etc.

It is appreciated that the illustrated computing device 1500 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The conversion of natural language expressions into corresponding computational independent model (CIM) syntax tree representations may serve to facilitate the proper resolution of pronominal references in the natural language and ensure that the eventually generated CIM rule expressions are semantically non-ambiguous. Thus, embodiments in accordance with this disclosure may aid in the efficient and error-free generation of software applications from the natural language expressions.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

We claim:

1. A computer readable medium storing computer-executable instructions that, when executed, cause one or more processors to perform acts comprising:
deriving a plurality of tokens from a natural language expression, each of the plurality of tokens including at least one word;
transforming the plurality of tokens into a computational independent model (CIM) syntax tree representation based on a CIM phrase tree model; and
presenting the CIM syntax tree representation.

2. The computer readable medium of claim 1, wherein the transforming includes:
segregating the plurality of tokens into subclauses based on the CIM phrase tree model;
projecting one or more base nominal expressions in each subclause based on the CIM phrase tree model;
projecting one or more base predicate expressions in each subclause based on the CIM phrase tree model;
projecting one or more base value expressions in each subclause based on the CIM phrase tree model;
projecting a sentential structure based on the CIM phrase tree model;
assembling the one or more base nominal expressions, the one or more base predicate expressions, the one or more base value expressions into one or more complex clauses based on the CIM phrase tree model; and
assembling a rule by projecting a correct type of intention for the one or more complex clauses based on the CIM phrase tree model, the rule including the CIM syntax tree representation.

3. The computer readable medium of claim 1, wherein the transforming includes parsing at least one of one or more conditional subclauses or one or more sentential expressions based on the CIM phrase tree model.

4. The computer readable medium of claim 1, wherein the transforming includes parsing one of a conditional subclause or a sentential expressions, the parsing comprising:
projecting one or more base predicate expressions in each subclause based on the CIM phrase tree model;
projecting one or more base nominal expressions in each subclause based on the CIM phrase tree model;
projecting one or more base value expressions in each subclause based on the CIM phrase tree model;
projecting a sentential structure based on the CIM phrase tree model; and
assembling the one or more base predicate expressions, the one or more base nominal expressions, the one or more base value expressions into one or more complex clauses based on the CIM phrase tree model.

5. The computer readable medium of claim 1, wherein the transforming includes one of projecting a verbal complex from one or more tokens of the plurality of tokens or projecting a pronominal reference from the one or more tokens based on the CIM tree representation.

6. The computer readable medium of claim 1, wherein the transforming includes processing helper verbs in a predicate complex.

7. The computer readable medium of claim 2, wherein the projecting of the sentential structure includes projecting a functional restrictive structure.

8. The computer readable medium of claim 2, wherein the projecting of the one or more base predicate expressions includes creating one or more predicate expressions from one or more tokens of the plurality of tokens.

9. The computer readable medium of claim 2, wherein the projecting of the one or more base predicate expressions includes creating one or more predicate expressions from one or more tokens of the plurality of tokens by determine whether at least one of the tokens is one of a modal token, an adverb token, a verb token, or a keyword token.

10. The computer readable medium of claim 2, wherein the projecting of the one or more base value expressions includes parsing value expressions from one or more tokens of the plurality of tokens.

11. The computer readable medium of claim 2, wherein the projecting of the one or more base value expressions includes parsing a value expression from one or more tokens of the plurality of tokens, the parsing including:
projecting one or more base value expressions from a value expression token array based on the CIM phrase tree model;
project one or more function restrictions from the value expression token array based on the CIM phrase tree model;
projecting a sentential structure based on the CIM phrase tree model that facilitates the projection of the functional restrictions;
assembling the one or more base values expression based on the CIM phrase tree model; and
determining a type for each of the one or more value expressions.

12. The computer readable medium of claim 11, wherein the parsing of the value expression from the one or more tokens further includes removing at least one of parentheses or quotes from ends of the value expression token array of the one or more tokens.

13. A method, comprising:
deriving a plurality of tokens from a natural language expression, each of the plurality of tokens including at least one word;
transforming the plurality of tokens into a computational independent model (CIM) syntax tree representation based on a CIM phrase tree model, the transforming including:
projecting one or more base nominal expressions in each subclause based on the CIM phrase tree model;
projecting one or more base predicate expressions in each subclause based on the CIM phrase tree model;
projecting one or more base value expressions in each subclause based on the CIM phrase tree model;
projecting a sentential structure based on the CIM phrase tree model;
assembling the one or more base nominal expressions, the one or more base predicate expressions, the one or more base value expressions into one or more complex clauses based on the CIM phrase tree model; and
assembling a rule by projecting a correct type of intention for the one or more complex clauses based on the CIM phrase tree model, the rule including the CIM syntax tree representation; and
presenting the CIM syntax tree representation.

14. The method of claim 13, wherein the transforming further includes parsing at least one of one or more conditional subclauses or one or more sentential expressions based on the CIM phrase tree model.

15. The method of claim 13, wherein the transforming further includes parsing one of a conditional subclause or a sentential expressions, the parsing comprising:
projecting one or more base predicate expressions in each subclause based on the CIM phrase tree model;
projecting one or more base nominal expressions in each subclause based on the CIM phrase tree model;
projecting one or more base value expressions in each subclause based on the CIM phrase tree model;
projecting a sentential structure based on the CIM phrase tree model; and
assembling the one or more base predicate expressions, the one or more base nominal expressions, the one or more base value expressions into one or more complex clauses based on the CIM phrase tree model.

16. The method of claim 13, further comprising constructing the CIM phrase tree model component to enable transformation of the plurality of tokens into a CIM syntax tree representation.

17. The method of claim 13, wherein the projecting of the one or more base predicate expressions includes creating one or more predicate expressions from the one or more tokens of the plurality of tokens.

18. The method of claim 13, wherein the projecting of the one or more base value expressions includes parsing value expressions from the one or more tokens of the plurality of tokens.

19. A system, comprising:
an input component to receive a plurality of tokens, the plurality of tokens being derived from a natural language expression;
a computational independent model (CIM) phrase tree model component to enable transformation of the plurality of tokens into a CIM syntax tree representation;
a CIM tree transformation algorithm component to transform the plurality of tokens into a CIM syntax tree representation based on the CIM phrase tree model; and
an output component to provide to present the CIM syntax tree representation.

20. The system of claim 19, wherein the CIM tree transformation algorithm component is to:
projecting one or more base predicate expressions in each subclause based on the CIM phrase tree model;
projecting one or more base nominal expressions in each subclause based on the CIM phrase tree model;
projecting one or more base value expressions in each subclause based on the CIM phrase tree model;
projecting a sentential structure based on the CIM phrase tree model; and
assembling the one or more base predicate expressions, the one or more base nominal expressions, the one or more base value expressions into one or more complex clauses based on the CIM phrase tree model.
